(19) United States
(12) Patent Application Publication
(10) Pub. No.: US 2026/0176199 A1
(43) Pub. Date: Jun. 25, 2026

(54) DENSIFIED ENGINEERED LIGNOCELLULOSIC COMPOSITE AND METHOD OF PREPARING THEREOF

(71) Applicant: 3C Technologies Inc., Vancouver (CA)

(72) Inventors: Radu Lucian MARCEA, North Vancouver (CA); Antoon Wilhelmus EGGENHUIZEN, Vught (NL); Robert BEDARD, Las Vegas, NV (US)

(21) Appl. No.: 19/328,015

(22) Filed: Sep. 12, 2025

Related U.S. Application Data
(60) Provisional application No. 63/737,596, filed on Dec. 20, 2024.
(60) Provisional application No. 63/737,599, filed on Dec. 20, 2024.

(51) Int. Cl. C04B 18/24; C04B 14/30; C04B 14/36; C04B 111/00

(52) U.S. Cl. CPC C04B 18/24; C04B 14/304; C04B 14/366; C04B 2111/00146

(57) ABSTRACT

The present disclosure relates to densified engineered lignocellulosic composites and methods for their fabrication.

This application claims priority under 35 U.S.C. § 119(a) to U.S. Provisional Application No. 63/737,599, filed on Dec. 20, 2024, and U.S. Provisional Application No. 63/737,596, filed on Dec. 20, 2024, the entire contents of each of which are incorporated herein by reference.

### 1. TECHNICAL FIELD

This disclosure relates generally to densified engineered lignocellulosic composites or components of such composites and methods for their fabrication.

### 2. BACKGROUND

With the advances in technology and the growing focus on environmental protection and sustainable development, the field of engineered materials is constantly pursuing the development of new materials. Lignocellulose-based composites have gradually become an important research topic because they not only possess the natural advantages of wood, such as renewability and good mechanical properties, but also have other advantages that cannot be matched by other materials, such as strong structural designability and easy functional modification. In the past few years, engineered lignocellulose-based composite materials, including densified wood, transparent wood, and bioinspired wood, have garnered widespread attention and research. These new materials possess advantages over traditional wood in terms of performance, while also offering additional enhanced and improved properties.

There have been attempts to use inorganic cementitious binders (mostly Portland Cement based) for manufacturing wood/fiber composites. However, these cementitious binders tend to be extremely alkaline, and the paste prepared from these materials is thick and cannot effectively impregnate the cells and capillaries of the cellulosic structure of the wood/fiber. As a result, the loading of these cementitious binders in the fibers is low, and the density of the resulting composites is unpredictable and irreproducible. Furthermore, previous attempts had limited success in maintaining the densified state of the fiber under conditions of variable moisture content (MC %) as lignocellulosic materials have a tendency of quickly reverting to the original dimensions.

Furthermore, it has been challenging to achieve engineered lignocellulosic composites with a uniform density. Fundamentally, cementitious materials and lignocellulosic fibers are characterized by substantially different density. As a result, combining these components to achieve a substantially uniform mixture, and in particular uniformity in mixture at spatial scales that encompass the size range of the individual lignocellulosic fibers, which would lead to significant enhancements in the capability to engineer lignocellulosic composites with a predictable density, has been a difficult goal and not achieved by prior known methods with any reproducibility. Therefore, there remains an unmet need for producing cementitious lignocellulosic composites with predictable properties using efficient, and environmentally friendly methods that produce reproducible results.

### 3. SUMMARY

The present disclosure is directed to cementitious lignocellulosic composites or components of such composites and methods of preparing thereof. The present cementitious lignocellulosic composites are dense, fire resistant, and have low porosity. These materials exhibit similar or superior mechanical properties to comparative non-inorganic fiber composites, but advantageously are flame retardant, fire resistant, free from volatile organic compound emissions, and have lower carbon footprint compared to organic polymer composites.

In some embodiments, a densified engineered lignocellulosic composite is disclosed. The densified engineered lignocellulosic composite of the present disclosure may comprise lignocellulosic fibers having a surface area and a cementitious material. The cementitious material covers the surface area of each of the lignocellulosic fibers. The cementitious material may be generated by a cement-forming additive reacting with one or more layers of mineral powder particles adhered to the lignocellulosic fibers by an adhering layer such that a substantially uniform coating of mineral powder particles covers the surface area of each of the lignocellulosic fibers. The lignocellulosic fibers and the cementitious material may be further compressed to form the densified engineered lignocellulosic composite.

In some embodiments, a coated lignocellulosic composite precursor is disclosed. The coated lignocellulosic composite precursor of the present disclosure may comprise lignocellulosic fibers having a surface area, a coupling agent, and mineral powder particles. The coupling agent may cover the outer surface of each of the lignocellulosic fibers. The coupling agent may generate an adhering layer on the surface area of the lignocellulosic fibers. Each of the mineral powder particles has a surface area. The mineral powder particles may form a substantially uniform coating on the surface area of each of the lignocellulosic fibers.

In some embodiments, a cementitious composite precursor is disclosed. The cementitious composite precursor of the present disclosure may comprise lignocellulosic fibers having a surface area, a coupling agent, and a cement-forming additive. The coupling agent may be applied to the surface area of each of the lignocellulosic fibers. The coupling agent may generate an adhering layer on the surface area of the lignocellulosic fibers. One or more layers of mineral powder particles may be applied to the coupling agent. Each of the layers may be applied as a substantially uniform coating around each lignocellulosic fiber. The mineral powder may react with the cement-forming additive to form a substantially uniform layer of the cementitious material on the surface area of the coated lignocellulosic fibers.

In some embodiments, a coated lignocellulosic fiber is disclosed. The coated lignocellulosic fiber of the present disclosure may comprise a surface area, a coupling agent, and mineral powder particles. The coupling agent may be applied to the surface area of the lignocellulosic fiber such that the coupling agent generates an adhering layer on the surface area of the lignocellulosic fiber. First layer of mineral powder particles may be adhered to the adhering layer of the coupling agent to form a substantially uniform coating covering the lignocellulosic fiber.

In some embodiments, a method of preparing a coated lignocellulosic composite is disclosed. The method may comprise drying a plurality of lignocellulosic fibers and applying a coupling agent on a surface area of lignocellulosic fibers, so that the coupling agent generates an adhering layer on the surface area of each of the lignocellulosic fibers. The method may further comprise applying mineral powder particles to the coupling agent to form a substantially uniform coating around each of the lignocellulosic fibers.

In some embodiments, a method of preparing a densified engineered lignocellulosic composite is disclosed. The method may comprise applying a coupling agent on a surface area of lignocellulosic fibers to generate an adhering layer, applying a first layer of a mineral powder particles to the adhering layer to form a substantially uniform coating around each fiber. The method may further comprise applying a cement-forming additive to the surface area of the fibers and positioning the coated lignocellulosic fibers in a substantially uniform arrangement as a mat such that a cementitious material is generated by the cement-forming additive reacting with one or more layers of the mineral powder particles adhered on the surface area of the lignocellulosic fibers. The method may further comprise compressing the lignocellulosic fibers and the cementitious material to form the densified engineered lignocellulosic composite.

In some embodiments, a method of generating an in situ softening agent on coated lignocellulosic fibers is disclosed. The method may comprise applying a substantially uniform coating of magnesium oxide powder particles to lignocellulosic fibers after the lignocellulosic fibers have been treated with a coupling agent on a surface area to form the coated lignocellulosic fibers. The method may further comprise applying ammonium polyphosphate to the coated lignocellulosic fibers such that the ammonium polyphosphate may react with the coating of magnesium oxide powder particles to generate in situ ammonia on the surface area of the lignocellulosic fibers as a softening agent.

### 4. BRIEF DESCRIPTION OF THE DRAWINGS

These and other features, aspects, and advantages of the present disclosure will become better understood with regard to the following description, and accompanying drawings, where:

FIG. 1 illustrates an exemplary coated lignocellulosic composite, according to embodiments of the invention.

FIG. 2 illustrates a lignocellulosic fiber coated with a layer of a coupling agent, according to embodiments of the invention.

FIG. 3 illustrates a lignocellulosic fiber coated with a layer of a mineral powder adhered to coupling agent, according to embodiments of the invention.

FIG. 4 illustrates a lignocellulosic fiber coated with two layers of a mineral powder adhered to coupling agent, according to embodiments of the invention.

FIG. 5 illustrates a lignocellulosic fiber coated with two layers of a mineral powder adhered to coupling agent, where a layering agent is further adhered to the surface of the mineral powder particle, according to embodiments of the invention.

FIG. 6 illustrates a lignocellulosic fiber surrounded by a layer or a carrier agent, where mineral powder particles are within or on the carrier agent, according to embodiments of the invention.

FIG. 7 illustrates a mat arrangement of coated lignocellulosic fibers, according to embodiments of the invention.

FIG. 8a illustrates a schematic of the formation of a cementitious composite precursor upon the addition of a cement-forming additive to the mat of coated lignocellulosic fibers, according to embodiments of the invention.

FIG. 8b illustrates a schematic of the formation of a cementitious composite precursor upon the addition of a cement-forming additive to the coated lignocellulosic fibers that are being formed into a mat, according to embodiments of the invention.

FIG. 9 illustrates a schematic of the densified lignocellulosic engineered composite, according to embodiments of the invention.

FIG. 10 illustrates a method of preparing a coated lignocellulosic composite precursor, according to embodiments of the invention.

FIG. 11 illustrates a method of preparing a densified engineered lignocellulosic composite, according to embodiments of the invention.

FIG. 12 illustrates a method of generating in situ softening agent on coated lignocellulosic fibers, according to embodiments of the invention.

FIG. 13 illustrates an exemplary method for preparing a densified engineered lignocellulosic composite, according to embodiments of the invention.

### 5. DETAILED DESCRIPTION

### 5.1. Definitions

When describing the embodiments of the present disclosure, the following terms, if present, have the following meanings unless otherwise indicated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible sub-ranges, fractional sub-ranges, and combinations of sub-ranges thereof, and will also include individual points and fractional points within those ranges. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

The term “densified,” as used herein, refers to compressed by heat and high pressure (e.g., pressure over 5-300 MPa) to increase its density, strength, stiffness and hardness.

The term “engineered lignocellulosic composite,” used interchangeably with the terms “engineered wood” or “composite wood” or “composite panel” or “wood panel” or “engineered panel,” as used herein, refers to a composite material made from lignocellulosic fibers, particles, or veneers bonded with adhesives. The composite offers strength and durability similar to solid wood.

The term “lignocellulose,” as used herein, refers to a complex biopolymer, composed of polysaccharides, such as cellulose and hemicellulose, lignin, and other components.

The term “lignocellulosic fiber,” as used herein, refers to a fibrous particle composed of cellulose fibers reinforced by a matrix of hemicellulose and either lignin or pectin in one or more layers, with the volume fraction and orientation of the cellulose fibers varying in each layer. Examples of lignocellulosic fibers include fibers of wood, straw, vines, and other fibrous materials. The term “lignocellulosic fibers” or “plurality of lignocellulosic fibers” encompasses more than one fiber, and may include a heterogenous mixture of fibers and wood chips that may be densified into a lignocellulosic composite.

The term “cementitious material,” as used herein, refers to a material that provides plasticity, cohesive, and adhesive properties when it is mixed with a cement-promoting liquid. In the presence of water, the liquid is a hydration liquid. Examples of cementitious materials include Portland cement, Portland-limestone cement, and magnesium-based inorganic cements.

The term “cement-forming additive,” as used herein, refers to a material that provides adhesive properties when it is mixed with a cement promoting liquid and/or water. Examples of a cement-forming additive include aluminum phosphate, sodium tripolyphosphate (STPP), monoammonium phosphate (MAP), diammonium phosphate (DAP), ammonium polyphosphate (APP), potassium dihydrogen phosphate, and sodium hexametaphosphate.

The term “mineral powder,” as used herein, refers to an inorganic material, such as, for example, an inorganic oxide or an inorganic salt, used in the preparation of a cementitious material. Examples of a mineral powder include calcium oxide (CaO), barium oxide (BaO), strontium oxide (SrO), magnesium oxide (MgO), magnesium hydroxide (Mg(OH)₂), calcium hydroxide (Ca(OH)₂), barium hydroxide (Ba(OH)₂), aluminum oxide (Al₂O₃), zinc oxide (ZnO), titanium dioxide (TiO₂).

As used herein, “uniform coating” means coated evenly and having the same thickness of coating throughout the coating. For example, a uniform coating covering the surface area of a fiber is an even coating on a fiber that has the same thickness on all surfaces of the fiber. A uniform coating on an outer surface of a fiber is an even coating on at least one outer surface of the fiber that has the same thickness on that outer surface.

As used herein, the term “mostly” means greater than 50% (i.e., greater than 50, 55, 60, 65, 70, 75, 80, 85, 86, 87, 88, 89, 90, 91, 92, 93, 94, 95, 96, 97, 98, 99, or 100%). For example, a mostly uniform coating on a fiber is a coating that is uniform over greater than 50% of the fiber. Thus, there may be some areas that are not entirely uniform but are mostly uniform.

As used herein, the term “substantially” means greater than 85% (i.e., greater than 85, 86, 87, 88, 89, 90, 91, 92, 93, 94, 95, 96, 97, 98, 99, or 100%). For example, a substantially uniform coating on a fiber is a coating that is uniform over greater than 85% of the fiber. Thus, there may be some areas that are not entirely uniform but it is fairly close to entirely uniform.

As used herein, the term “highly” means greater than 95% (i.e., greater than 96, 97, 98, 99, or 100%). For example, a highly uniform coating on a fiber is a coating that is uniform over greater than 95% of the fiber. Thus, there may be some areas that are not entirely uniform but it is very close to entirely uniform. As used herein, the term “covering” means covering at least one portion of. The term “covering the surface area of” means covering nearly entirely. For example, covering the surface area of a fiber with mineral powder means nearly entirely encompassing the fiber and covering nearly entirely all surfaces of the fiber. The term “covering an outer surface of” means covering at least one outer surface of. The term “covering most of” means covering more than 50% of. The term “covering substantially all of” means covering greater than 85% of. The term “covering nearly entirely” means covering greater than 95% of. The term “covering entirely” means covering all, covering every surface of, or encompassing entirely.

The term “relative humidity,” as used herein, refers to a present state of absolute humidity relative to a maximum humidity given the same temperature of a given gas (or atmosphere).

The term “dimensional stability,” as used herein, refers to the capability of a material to maintain its original dimensions and shape despite changes in environmental conditions or applied stresses.

The term “recycle,” as used herein, refers to reprocessing, such as reprocessing a material into useful products.

The term “softening agent,” as used herein, refers to a material capable of temporarily softening lignocellulosic fibers by temporarily modifying/altering its chemical structure.

The term “coupling agent,” as used herein, refers to a material that causes coupling of two entities, such as an adhesive material, or that acts as a chemical bridge between two incompatible substances.

The term “layering agent,” as used herein, refers to a material that causes coupling of two entities where one of the entities is layering on another. A coupling agent may be used as a layering agent. An adhesive material is an example of a layering agent.

The term “temporarily soften,” as used herein, refers to a temporary change of structure of a lignocellulosic fiber upon the interaction with a softening agent.

The term “adhering layer,” as used herein, refers to a layer that adheres or causes entities on each side of the adhering layer to adhere or connect to each other. For example, mineral powder particles may be adhered to lignocellulosic fibers by an adhering layer. The adhering layer can be any layer or form of adherence, including but not limited to an adhesive (e.g., glue, cement, paste, epoxy, polyurethane, spray glue, etc., adherence by hydrostatic forces, by hydrodynamic forces, by covalent chemical bonding, by intermolecular forces, by cohesion etc.).

The term “tacky layer,” as used herein, refers to a layer retaining a slightly sticky feel or that allows two entities to be lightly or loosely or temporarily adhered, such as an adhesive (e.g., glue, cement, paste, epoxy, polyurethane, spray glue, resin, mastic, etc.). The layer is tacky until it is covered by another layer, such as a powder.

The term “adhesive,” as used herein, refers to any non-metallic substance applied to one or both surfaces of two separate items that binds them together and resists their separation.

The term “foaming agent,” as used herein, refers to a material such as a surfactant or a blowing agent that facilitates the formation of foam.

The term “in-situ generated,” or “generated in situ” as used herein, refers to a material generated during a chemical reaction at the location where it is used.

The term “bone dry,” as used herein, refers to a material completely devoid of moisture or wetness.

The term “moisture content,” as used herein, refers to the quantity of water (moisture, or wetness) in a material. In some embodiments, the lignocellulosic fibers have a moisture content of less than 30%, 25%, 20%, 19%, 18%, 17%, 16%, 15%, 14%, 13%, 12%, 11%, 10%, 9%, 8%, 7%, 6%, 5%, 4%, 3%, 2%, or 1%.

### 5.2. Overview

The composites disclosed have superior properties and advantages related to being flame retardant and having a beneficial thermal conductivity, resistance to fungus attack and/or rotting under moist conditions, ability to resist pest infestation and ability to be recycled. The composites are also free from volatile organic compound emissions, have lower carbon footprint compared to organic polymer composites, have good stability, have uniform density that is reproducible in manufacturing, have low porosity, and generally have similar or superior mechanical properties to comparative non-inorganic fiber composites.

The composites described throughout may be lignocellulosic composites, such as those made with wood fibers, though other types of composites may also be made. The composites may be densified in some embodiments, but other embodiments are not densified or are partially densified. They may also be cementitious lignocellulosic composites that are made using a cement-type material or other material that provides a hardening or solidifying to the composite. In some embodiments, the composite is a densified engineered lignocellulosic composite, such as an engineered wood or a composite panel. A densified engineered lignocellulosic composite material is described throughout as an example embodiment for illustration, though the disclosure is not limited to this embodiment.

The densified engineered lignocellulosic composite may include lignocellulosic fibers and a cementitious material. More specifically, the composite may be made up of three main ingredients, lignocellulosic fibers, mineral powder (e.g., magnesium oxide or MgO), and a cement-forming additive (e.g., ammonium polyphosphate). The lignocellulosic fibers may be a heterogenous mixture of fibers, wood chips, etc. that have many different shapes and sizes, and may include crevices within the individual fibers. To make the composite, the lignocellulosic fibers are softened so that they may take a different shape, allowing them to be compressed and so densified into an engineered wood. This softening can be done chemically, for example by ammonia, which enters the lignin and cellulose and opens the sugars. This softening, such as by a chemical softening step, can facilitate densification and overcome brittleness during shaping. In exemplary embodiments, the lignocellulosic material is exposed to ammonia, either in gaseous or liquid form. In examples where the mineral powder is MgO and the cement-forming additive is liquid ammonium polyphosphate, at the location where these two materials are combined, there is a release of aqueous ammonia. Upon exposure, the ammonia permeates into the cell wall microstructure of the lignocellulosic material and disrupts intermolecular hydrogen bonding between adjacent cellulose chains, while also interacting with the lignin matrix. This interaction induces swelling of the lignin-hemicellulose-cellulose network, increases molecular chain mobility, and temporarily plasticizes the fibers. The softening effect of ammonia takes place on the surface of the uniformly coated fiber, penetrating into the volume of the lignocellulosic fiber and softening the lignin-hemicellulose-cellulose network uniformly across the volume of the fiber. In this softened state, the lignocellulosic elements can be reconfigured, compressed, or bent without structural fracture before hardening occurs, permitting the formation of high-density, dimensionally stable composites. In situ generated aqueous ammonia may become more mobile withing the mixture of the materials.

However, making a uniform composite in a reproducible manner is not possible with any prior techniques for making composites. When mixing the three components, such as the lignocellulosic fibers, the MgO and the ammonium polyphosphate, the cementitious material starts hardening within seconds, so it is very difficult to have these components well-mixed in time to do the densification, and impossible to get a uniform construction in a reproducible manner. In particular, achieving uniformity of blended material down to the level of coating the surface area of the individual lignocellulosic fibers (including the surface areas of the fibers and wood chips that may make up a heterogenous mixture of lignocellulosic figures) with a layer of uniform thickness of cementitious powder has not been achieved in any reproducible way in the state of the art. Indeed, it is known that naive and direct mixing of the three components generally produces a non-uniform coating of the individual fibers. This problem has been solved in the composites described herein through various techniques disclosed in this patent application.

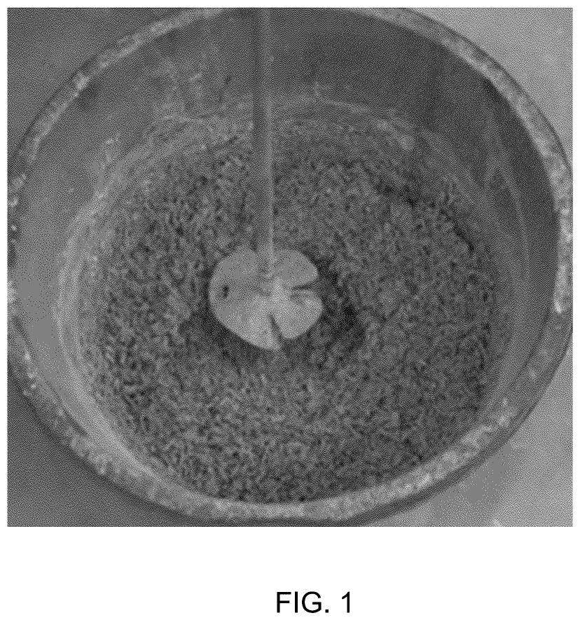

In some embodiments, there is a precursor made for the composite. The precursor may be a coated lignocellulosic precursor. This precursor may be made up of lignocellulosic fibers and a mineral powder (e.g., magnesium oxide or MgO). Since the fibers and the powder have different densities, these cannot be readily mixed since the powder, having a higher density than the fiber, will settle to the bottom of the mixture during mixing. To address this issue, the precursor is designed to coat the lignocellulosic fibers with the mineral powder. In one embodiment, in a heterogeneous mixture of lignocellulosic fibers, the precursor is designed to coat the entire surface area such that each fiber and wood chip, and even the irregular surfaces and crevices, are coated with the mineral powder. The coating may also be a uniform coating. A photograph of what such a heterogenous mixture of lignocellulosic fibers looks like is provided in FIG. 1.

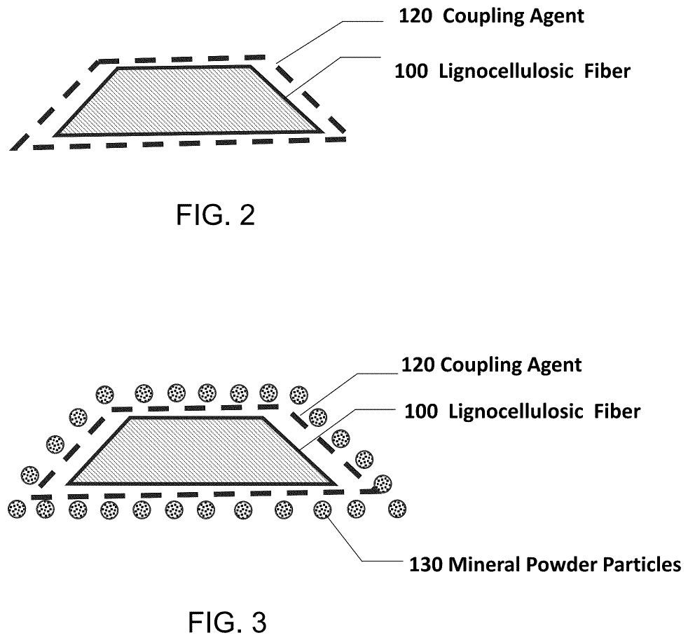

There may be various ways in which the lignocellulosic fibers are coated. FIGS. 2-6 provide illustrations of coating a lignocellulosic fiber 100 according to an embodiment. One way in which the precursor may be designed to coat the lignocellulosic fibers 100 is by having the precursor include a coupling agent 120 covering the surface area of each of the lignocellulosic fibers, as shown in FIG. 2. In one embodiment, the coupling agent generates an adhering layer on the surface area of the fibers, though it is not required that it create an adhering layer since adherence may occur in various ways. In some embodiments, the coupling agent 120 comprises the forces between the fiber 100 and the mineral powder 130 that provides the coupling, and these forces may be the adhering layer. In some embodiments, the coupling agent 120 is a tacky layer, but is not so sticky that it causes the fibers 100 to stick together or clump. Preferentially, any fiber that is coated with the coupling agent will adhere to mineral powder instead of adhering to other fibers that are coated with the coupling agent, because the powder-to-coupling-agent interaction is stronger and less transient than the coupling-agent-to-coupling-agent interaction, and because the fibers are substantially coated in the coupling agent. In some embodiments, this coupling agent 120 is sufficient to allow the lignocellulosic fibers 100 to be entirely coated with a uniform or substantially uniform coating of mineral powder 130, as illustrated in FIG. 3.

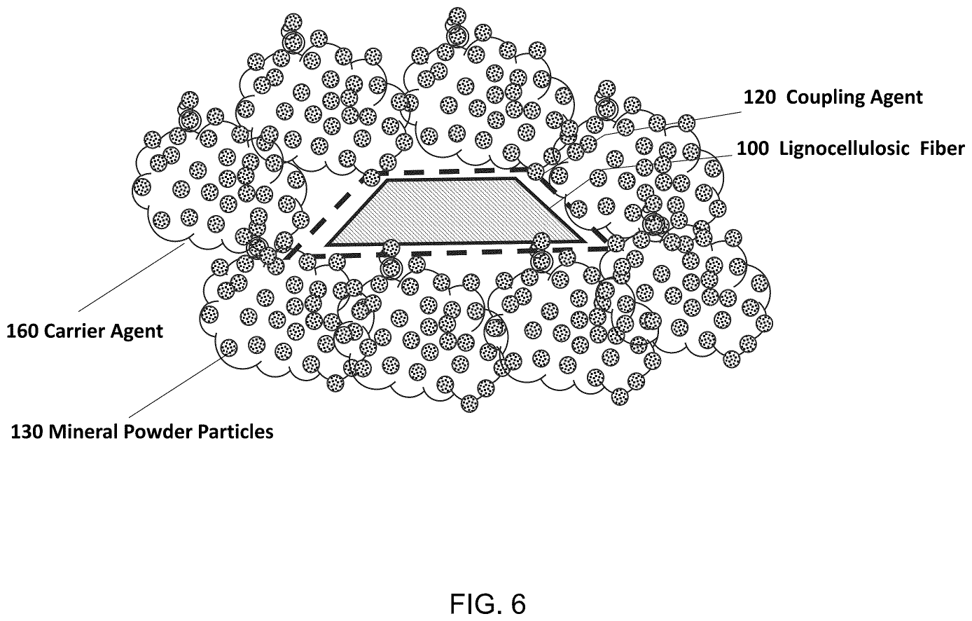

In other embodiments, the coupling agent 120 allows the powder 130 to adhere to the surface of the fibers 100, but it still will not form a uniform coating or it may form a uniform coating but not meet the desired thickness. To address the different densities of the fibers 100 and the powder 130 in this instance, the powder 100 may be added to a carrier or carrier agent 160 (e.g., liquid, gas, a spray-liquid, spray-gas, aerosol, aerogel, mineral, paper, powder, dye, rubber, ceramic, plastic, textile, chemical, stone, plaster, fiber, composite, glass, foam, fluid, alloy, polymer, biomaterial, crystal material, superalloy, slurry, adhesive, etc.), as illustrated in FIG. 6. In one embodiment, the carrier 160 acts as an intermediate suspension that neutralizes the difference in the density of the powder 130 and the bulk-density of the fibers 100. For example, the carrier can be a transient material that has a particular form for a period of time but then changes form such that the carrier 160 suspends the powder on its surface or on the surfaces of its components and allows the powder to be deposited on the fibers as a uniform or substantially uniform coating surrounding or covering the surface area fibers after mixing.

Alternatively, the powder may also be deposited on the fibers by spraying or rubbing against each other in a high-shear mixer.

Since the lignocellulosic fibers are dried before being formed into a composite and since the carrier 160 may provide more moisture to the fibers, the liquid from the carrier 160 may be drawn into the drier fiber such that the powder on the carrier surface(s) is left behind to be uniformly deposited on the fibers as a jacket to encase them, and may cover all of the surfaces of all of the fibers, or may cover substantially all of the surfaces. The covering may also be deposited onto irregular surfaces and into crevices, corners, or pockets in a heterogeneous fiber mixture.

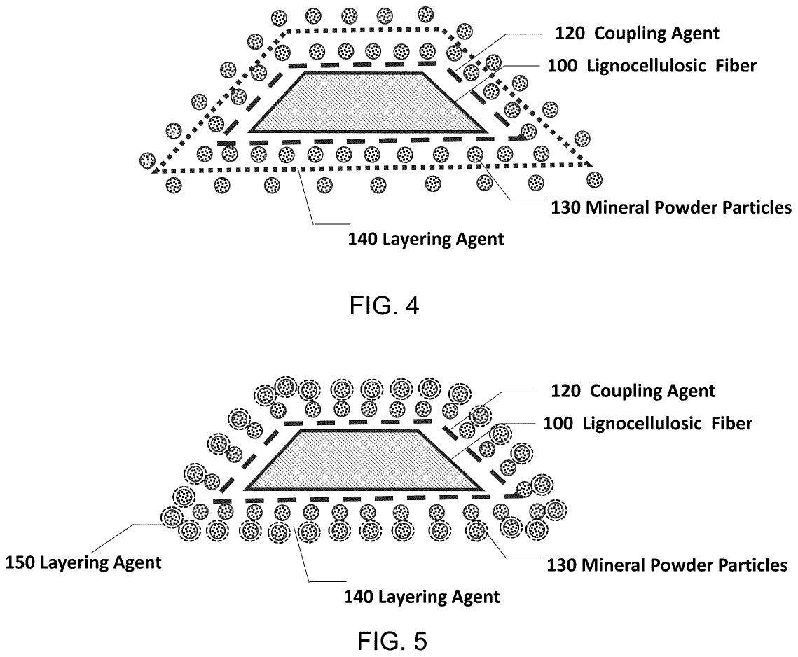

Additional layers of powder may also be desired to make a thicker covering on the fibers 100. An exemplary method of doing this is shown in FIG. 4. However, the adhering layer is now covered with powder 130 such that more powder will not adhere to the fibers. To address this, a layering agent 140 can be added to the powder 130, as shown in FIG. 4, which may coat the surface area of the powder particles 130 to make them able to adhere or make them tacky or adhering on their outer surface or surface area. The coated powder particles 130 can then be deposited on the powder coated fibers. The powder particles may be deposited in the same manners that were described above for depositing powder particles onto the uncoated fiber. For example, the coated powder particles may be sprayed onto the coated fibers.

Another example of a way to add additional layers of powder is illustrated in FIG. 5. In this case, the powder particles 130 themselves may have a layering agent 150 that allows them to adhere to the layer of powder particles 130 already adhered to the fiber 100. The process then can be repeated until the desired powder to fiber loading is achieved. FIG. 5 shows the layering agent 150 around the mineral powder particles 130 but in some embodiments, the layering agent 150 surrounds the mineral powder particles 130 by being contained within a carrier, such as carrier agent 160 (e.g., a liquid, gas, foam, etc.) in FIG. 6 that holds or deposits the layering agent 150 on the mineral powder particles 130.

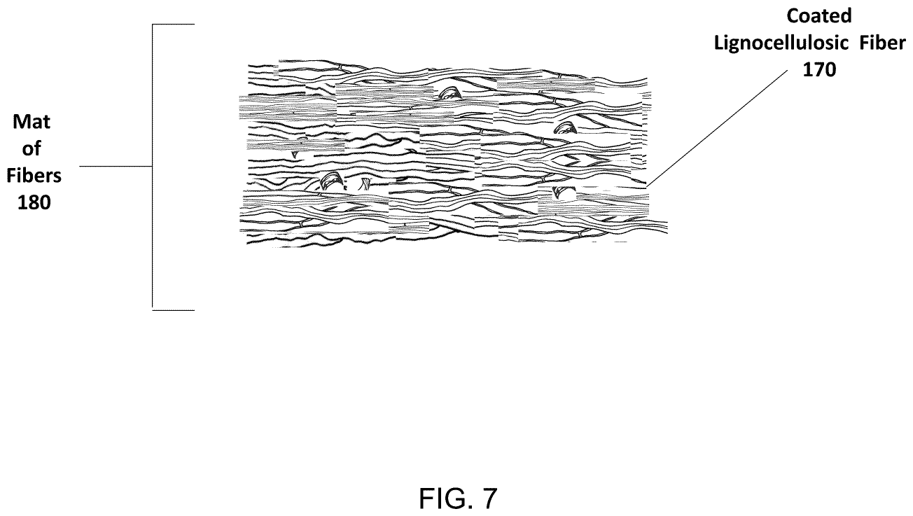

With the uniform coating of one or more powder layers, the coated lignocellulosic fibers 170 can now be easily handled without sticking to one another. As shown in FIG. 7, the coated lignocellulosic fibers 170 can be arranged into a form, such as a substantially uniform arrangement or a mat 180 to be compressed. The fibers can be aligned in the mat 180 in any fashion desired including in an organized fashion parallel to one another. The cement-forming additive can then be added to a pre-arranged mat or other form ready to be densified, or the cement-forming additive can be added to the fibers as they are being arranged into the mat or as they are falling onto a platform or conveyor belt. This is a substantial improvement over the conventional technique of trying to mix the components (fibers, mineral powder, cement former) in a vat altogether in hurry before the cement forms and then trying to rapidly arrange them for compression. The conventional technique results in a composite with fibers that are not well arranged and so the composite is weaker and does not have the advantageous properties of the composite described here.

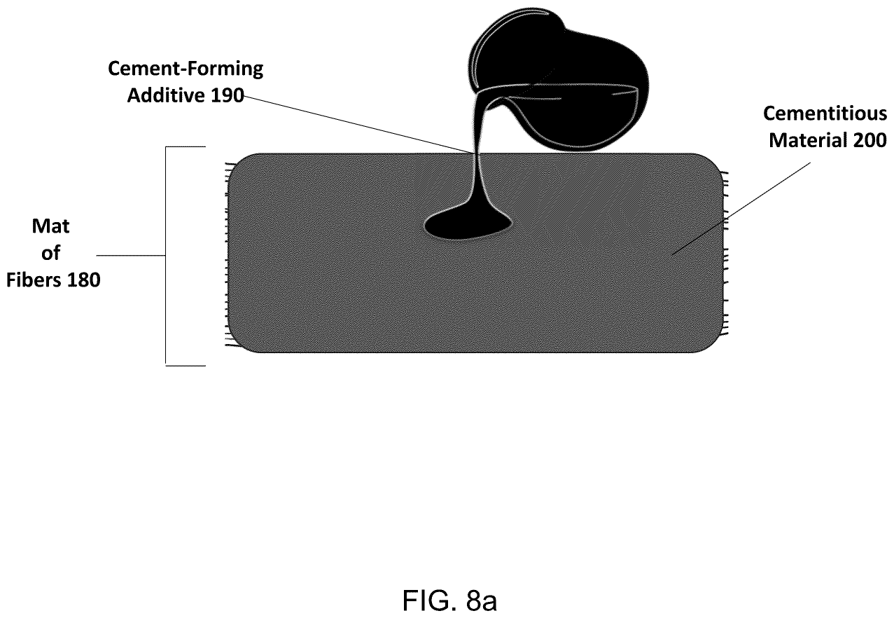

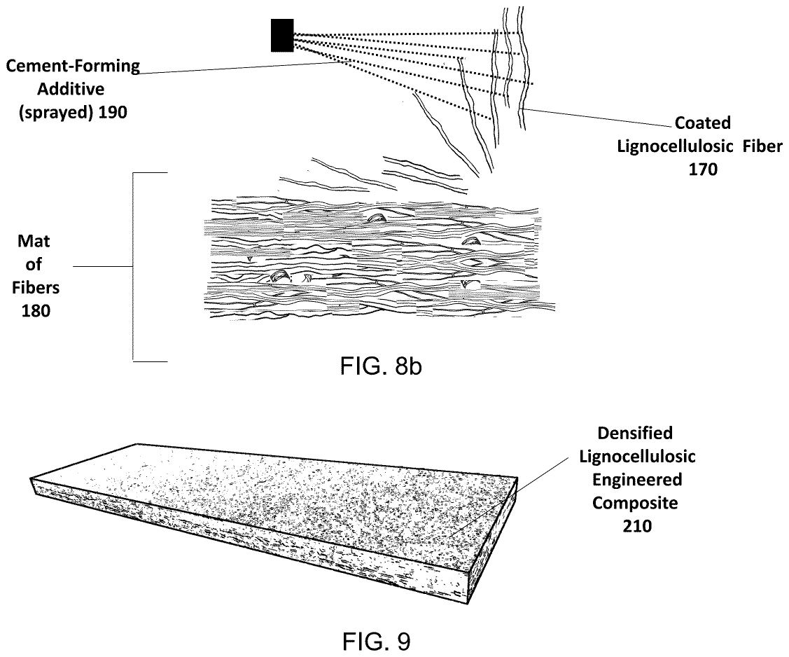

A cementitious composite precursor forms when the cement-forming additive 190, as shown in FIGS. 8a and 8b, is added to the coated fibers that will be arranged in a form, such as a mat 180. The cement-forming additive 190 can be added to the mat 180 as shown in FIG. 8a after the mat 180 is formed, or it can be added as shown in FIG. 8b while the mat is being formed. The cementitious composite precursor forms right before the hardening occurs into the cementitious material 200. The resulting mixture is then subjected to a densification stage, which may comprise uniaxial or isostatic pressing at a pressure sufficient to compact the fibers into an engineered construction article. Subsequent removal of ammonia, by evaporation, vacuum, or neutralization, allows the reformation of hydrogen bonds within the lignocellulosic cell walls, thereby locking the fibers in their densified geometry while the cementitious reaction progresses to develop final strength. This may be compressed or densified into the final densified composite 210, as shown in FIG. 9. The uniform coating on the fibers allows ammonium polyphosphate, for example, in the cementitious composite precursor to react with MgO powder, for example, to form ammonia that softens the fibers for compression. The ammonia forms right on the surface of each fiber along the fibers' encasement in powder as an in situ generated ammonia. The wood and cement become bonded at a chemical level with a strong bond that no longer appears as a sugar that might be food for bacteria and fungi, so it is unlikely to rot and makes the resulting composite very strong. The result is a magnesium oxy phosphate (MOP) cementitious material as part of a densified engineered lignocellulosic composite that can re reproducibly formed with a uniform cementitious coating, enhanced density, and improved mechanical and durability performance compared to composites prepared via direct mixing without prior softening. The components of the composite are each described in more detail below.

### 5.3. Cementitious Material

The densified engineered lignocellulosic composite presented throughout includes a cementitious material. The cementitious material 200 is illustrated in FIG. 8 according to one example embodiment. The cementitious material 200 binds the lignocellulosic fibers 100 in a lignocellulosic composite. Cementitious materials are foundational in producing concrete, mortar, grouts, fiber-cement boards, masonry units, engineered composites, densified lignocellulosic products, and repair materials. Cementitious materials refer to any inorganic binder composition that, upon combination with water or a water-containing reactant, undergoes a chemical setting and hardening reaction to form a cohesive and mechanically stable matrix capable of binding particulate or fibrous substrates.

In the context of the present lignocellulosic composite, the cementitious material comprises at least one mineral powder component, such as magnesium oxide (MgO), and at least one cement-forming additive, such as ammonium polyphosphate, that together produce a cementitious reaction product. In certain embodiments, reaction between the mineral powder and the cement-forming additive may generate ancillary species (e.g., aqueous ammonia) that permeate and temporarily soften the lignocellulosic fibers, facilitating mechanical deformation, compression, and densification during composite formation. Commonly used cementitious materials include, for example, but are not limited to, magnesium-based cements, calcium-based hydraulic cements, phosphate cements, pozzolanic binders, and combinations thereof.

Magnesium-based inorganic cements, such as magnesium carbonate, phosphate, silicate-hydrate, and oxysalt cements, are suited to specialist applications in precast construction, road repair, and other fields including nuclear waste immobilization. The majority of MgO-based cements are more expensive to produce than Portland cement because of the relatively high cost of reactive sources of MgO. This precludes MgO-based cements from providing a large-scale replacement for Portland cement in the production of steel-reinforced concrete for civil engineering applications, despite the potential for CO₂ emissions reductions offered by some such systems.

The magnesium oxyphosphate (MOP) cement is of interest to industry as quick setting cements. Being quick setting, MOPs offer a solution to repair works where the down time is of essence. Advantages of MOP cements include rapid setting, strong adhesion to diverse substances, lower alkalinity when compared to Portland cement, dimensional stability, low shrinkage, high density and hardness, as well as acid and salt resistance. Moreover, MOP cements are also fire resistant and are used in repairs where refractory properties are required (Walling et al., Chem. Rev. 2016, 116, 4170-4204).

However, little effort has been made in pursuing wood/fiber composites using magnesium-based phosphates, such as magnesium oxyphosphate (MOP). Previous attempts using magnesium di-hydroxyphosphates in water solutions did not yield convincing results as the conversion of the resulting paste into a usable building material was not feasible.

In some embodiments, the densified engineered lignocellulosic composite presented throughout comprises a cementitious material. In some embodiments, the cementitious material comprises a magnesium-based cement.

The cementitious material may comprise magnesium oxide (MgO). MgO-based cements are advantageous due to the lower temperatures required for the production of MgO. Equally, the ability of MgO to absorb CO₂ from the atmosphere to form a range of carbonates and hydroxycarbonates makes MgO-based cements environmentally friendly.

In some embodiments, the cementitious material is a magnesium phosphate cement. In some embodiments, the cementitious material is a magnesium silicate hydrate cement, a magnesium oxychloride cement, or a magnesium oxysulfate cement.

In some embodiments, the cementitious material is a magnesium phosphate cement.

Magnesium phosphate cements are formed through an acid-base reaction between MgO and a soluble acid phosphate (typically an ammonium or potassium phosphate), forming a magnesium phosphate salt with cementitious properties as exemplified by the following reaction:

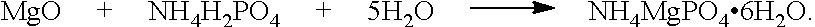

In some embodiments, the magnesium-based cement is magnesium oxyphosphate. In some embodiments, the magnesium oxyphosphate is prepared using ammonium polyphosphate and magnesium oxide. The major reaction products develop at room temperature and were found to be ternary phases of NH₄MgPO₄·6H₂O and Mg₃(PO₄)₂·4H₂O hydrated crystals.

NH₄MgPO₄·6H₂O has been demonstrated to be unstable from 50° C. in air, decomposing through the following reaction:

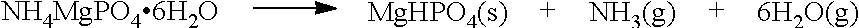

Ammonia (NH₃) released in the decomposition process of NH₄MgPO₄·6H₂O is referred herein as “in-situ generated ammonia”.

To facilitate high-density formation without fracturing the fibers, the lignocellulosic material is softened prior to or during densification. In certain advantageous embodiments, softening is achieved in sit during the cementitious reaction. When the mineral powder (e.g., MgO) is combined with the cement-forming additive (e.g., liquid ammonium polyphosphate) in the presence of water, the reaction generates ammonia (NH₃) as a by-product. The in-situ generated ammonia dissolves readily in the available water phase and permeates into the lignocellulosic fibers, where it disrupts hydrogen bonding between cellulose molecules and interacts with lignin, causing swelling and temporary plasticization of the fiber matrix.

This transient softening enables the lignocellulosic elements to be mechanically deformed, compressed, and densely packed while achieving uniform distribution and coating of the cementitious phase over the fiber surfaces, including within surface recesses and cell wall voids. Once the desired densified geometry is formed, the ammonia is removed through the application of heat at a temperature in excess of about 150° C. This heat treatment evaporates the ammonia, allowing hydrogen bonds within the cellulose-lignin network to reform, thereby restoring the inherent stiffness and strength of the lignocellulosic material while the cementitious matrix cures to final hardness.

In certain embodiments, the ammonia vapor produced during removal is captured via condensation to yield an aqueous ammonia solution. The recovered aqueous ammonia can be returned to the process and reused, thereby establishing a circular ammonia economy that reduces waste, minimizes environmental release, and lowers raw material consumption.

The resulting composite exhibits a reproducible, uniform cementitious coating on individual lignocellulosic elements, high density, enhanced mechanical properties, and improved durability relative to composites produced without the in-situ ammonia softening and recovery cycle.

### 5.4. Lignocellulosic Fiber

The densified engineered lignocellulosic composite presented throughout includes a plurality of lignocellulosic fibers. The lignocellulosic fibers 100 are illustrated in FIGS. 2-7 according to exemplary embodiments.

Lignocellulosic fibers are composed of terrestrial lignocellulose. Terrestrial lignocellulose is the most abundant, and most easily harvested type of non-edible biomass. Lignocellulose is a complex biological material found in plant cell walls, primarily composed of cellulose, hemicellulose, and lignin. These components are organized into microfibrils and macrofibrils, providing structural stability to plant cell walls. In the context of construction, lignocellulose can be used as a sustainable material due to its abundance and renewable nature. Lignocellulosic nanomaterials are able to enhance the properties of construction and building materials by acting as a reinforcement to the concrete, coating for woods, and nanofiller for polymer composites.

Lignocellulosic fibers may include plant-derived fibrous materials comprising, on a dry weight basis, primarily cellulose, hemicellulose, and lignin, optionally along with minor natural extractives, resins, or inorganic constituents. Lignocellulosic fibers encompass fibers, filaments, strands, particles, chips, shavings, flour, or other comminuted forms derived from wood (including hardwood and softwood species), bamboo, grasses, agricultural residues (e.g., straw, bagasse, husks, stems), bast fibers (e.g., hemp, flax, jute, kenaf), or other lignocellulosic biomass sources. Such fibers may be of heterogeneous size, geometry, and morphology, including mixtures of elongated fibers and more equiaxed particles, and may possess surface irregularities, pores, or crevices inherent to plant cell wall structures.

In some embodiments, the densified engineered lignocellulosic composite presented throughout comprises lignocellulosic fiber.

Any cellulosic material can be used in providing the densified engineered lignocellulosic composite, and in carrying out the methods disclosed and described herein. Lignocellulosic fiber can be obtained in various forms that include, but are not limited to, hardwood and softwood fibers obtained from wood or plant materials. The fibrous materials can be wood veneer, short and long flakes, strands, saw dust, wood particles, fiber bundles, and/or raw material obtained by different pulping methods such as, stone ground wood (SGW), pressure ground wood (PSW), refiner mechanical pulp (RMP), thermo mechanical pulp (TMP), chemi-thermo-mechanical pulp (CTMP), Kraft pulp, soda pulp, and bleached pulp. Fibrous materials also include different plant fibers such as com silk, seed fibers, leaf fibers, bast (skin) fibers, fruit fibers, and stalk fibers. The lignocellulosic fibers can be a heterogenous mixture of different types of materials, including fibers of different sizes wood chips, etc. Lignocellulosic materials are inclusive of thin sheets of wood or pressed wood forms, for example, veneers and the like. Lignocellulosic materials are inclusive of long fibers and short fibers. These exemplary examples of raw materials are referred to hereafter without any limitations as “lignocellulosic materials” or interchangeably as “lignocellulosic fiber.”

Naturally available lignocellulosic materials suitable for development of composites with lignocellulosic materials include lignin, hemi-cellulose, cellulose, and extractives. In some embodiments, the lignocellulosic fiber comprises a plurality of lignocellulosic fiber particles. Lignocellulosic fiber particles may be present in a form of chips. Chips may be obtained from natural sources such as straw, vines, and dry plant residues. Lignocellulosic fiber may be selected from wood fiber, plant fiber, or a mixture thereof.

Lignocellulosic fiber particles may be reduced in size and reduced into shape and desired slenderness ratio as dictated by the sought strengths and properties of the final engineered composite product.

Lignocellulosic fibers may be dried to a certain moisture content (MC %). In some embodiments, the MC % is at least 10%, at least 11%, at least 12%, at least 13%, to promote a uniform deposition of the mineral powder, and at least 14%, at least 15%, at least 16%, at least 17%, at least 18%, at least 19%, or at least 20% to promote complete hydration of the cementitious crystals.

In certain embodiments, as described herein, the lignocellulosic fibers are capable of undergoing temporary plasticization upon exposure to a chemical softening agent such as ammonia, allowing mechanical deformation, compression, or densification without fracture. The fibers can subsequently recover rigidity upon removal of the softening agent, thereby maintaining a desired shape, while being at least partially coated or embedded within a cementitious matrix.

### 5.5. Densified Engineered Lignocellulosic Composite

The present disclosure is directed to novel densified engineered lignocellulosic composites and methods of preparing thereof. The densified engineered lignocellulosic composite of the present disclosure overcomes common issues intrinsic to wood composites, such as moisture sensitivity, dimensional instability, biological degradation, adhesive limitations, fire performance, and low mechanical strength.

A densified engineered lignocellulosic composite 210 is illustrated in FIG. 9 according to one exemplary embodiment. This resolves issues of the dimension recovery or rebound of the densified lignocellulosic materials after removing of softening agents from the process. This composite encapsulates the lignocellulosic material into a hydrated ceramic/cementitious matrix that is chemically bonded to the lignocellulosic material and endows this material with fire- and rot resistant properties.

The densified engineered lignocellulosic composite of the present disclosure comprises a plurality of lignocellulosic fibers. Lignocellulosic fibers may be selected from wood fiber, plant fiber, or a mixture thereof.

Each of the lignocellulosic fibers has an outer surface area, which may be further covered by a cementitious material. In some embodiments, the cementitious material comprises a magnesium-based cement. In some embodiments, the cementitious material comprises magnesium oxide powder particles.

In some embodiments, the cementitious material may be generated when a cement-forming additive reacts with one or more layers of mineral powder particles. In some embodiments, the cement-forming additive is an inorganic salt. In some embodiments, the cement-forming additive is chosen from calcium sulphate, sodium sulphate, calcium carbonate, sodium carbonate, ammonium polyphosphate. In some embodiments, the cement-forming additive is ammonium polyphosphate. In some embodiments, ammonium polyphosphate is in a liquid form. In some embodiments, the mineral powder is a metal oxide. In some embodiments, the mineral powder is chosen from calcium oxide, aluminum oxide, ferric oxide, magnesium oxide, potassium oxide, zinc oxide, titanium oxide, and manganese oxide. In certain embodiments, the metal oxide is magnesium oxide.

In some embodiments, mineral powder particles may be adhered to the outer surface area of each of the lignocellulosic fibers as a substantially uniform coating.

In some embodiments, the lignocellulosic fibers and the cementitious material are compressed to form the densified engineered lignocellulosic composite.

The densified engineered lignocellulosic composite is strongly fire resistant due to the high number of hydration water molecules in each mineral crystal, which provides for a long-term sequestration of carbon contained in the lignocellulosic material due to its chemical incorporation in the mineral matrix. The product can be ground and reused in the manufacturing process as a portion of the raw materials as it exhibits good reactivity and compatibility with fresh ingredients.

In some embodiments, the densified engineered lignocellulosic composite is resistant to fire. In some embodiments, the densified engineered lignocellulosic composite may exhibit a thermal conductivity of at least 0.1 W×m⁻¹×K⁻¹ to at least 5 W×m⁻¹×K⁻¹, at least 1 W×m⁻¹×K⁻¹ to at least 5 W×m⁻¹×K⁻¹, at least 2 W×m⁻¹×K⁻¹ to at least 4 W×m⁻¹×K⁻¹, at least 3 W×m-ix K⁻¹ to at least 4 W×m⁻¹×K⁻¹, at least 1 W×m⁻¹×K⁻¹ to at least 2 W×m⁻¹×K⁻¹, at least 0.1 W×m⁻¹×K⁻¹ to at least 1 W×m⁻¹×K⁻¹, or at least 0.1 W×m⁻¹×K⁻¹ to at least 2 W×m⁻¹×K⁻¹, as determined by laser flash analysis. In some embodiments, the densified engineered lignocellulosic composite may exhibit a thermal conductivity ranging from 0.9 to 1.9 W×m⁻¹×K⁻¹, as determined by laser flash analysis.

In some embodiments, the densified engineered lignocellulosic composite exhibits a dimensional stability of at least 1 mm/m to at least 10 mm/m. The term “dimensional stability,” as used herein, refers to the capability of a material to maintain its original dimensions and shape despite changes in environmental conditions or applied stresses. In some embodiments, the densified engineered lignocellulosic composite exhibits a dimensional stability of at least 1 mm/m to at least 8 mm/m, at least 1 mm/m to at least 6 mm/m, at least 1 mm/m to at least 4 mm/m, least 1 mm/m to at least 2 mm/m, at least 2 mm/m to at least 10 mm/m, at least 2 mm/m to at least 8 mm/m, at least 2 mm/m to at least 6 mm/m, at least 2 mm/m to at least 4 mm/m, at least 4 mm/m to at least 10 mm/m, at least 4 mm/m to at least 8 mm/m, or at least 4 mm/m to at least 6 mm/m.

In some embodiments, the densified engineered lignocellulosic composite exhibits a dimensional stability of at least 1 mm/m to at most 3 mm/m when fully submerged in water.

The densified engineered lignocellulosic composite is dimensionally stable when exposed to water or variable relative humidity (RH %) in the air. In some embodiments, the densified engineered lignocellulosic composite is substantially dimensionally stable under relative humidity (RH) of at least 50%, at least 60%, at least 70%, at least 80%, or at least 90%.

The densified engineered lignocellulosic composite is recyclable. In some embodiments, the densified engineered lignocellulosic composite is recyclable.

In some embodiments, the densified engineered lignocellulosic composite comprises a lignocellulosic fiber. In some embodiments, the lignocellulosic fiber is selected from wood fiber, plant fiber, or a mixture thereof. In some embodiments, the lignocellulosic fiber is wood fiber. In some embodiments, the lignocellulosic fiber is plant fiber. The lignocellulosic fiber as used in the present disclosure is fine.

In some embodiments, the plurality of lignocellulosic fibers is temporarily softened by an in situ generated softening agent generated by reacting the cement-forming additive with the one or more layers of mineral powder particles. In some embodiments, the in situ generated softening agent is ammonia. The in-situ generated ammonia dissolves in the available water and reacts with the lignocellulosic fibers. As a result, the lignocellulosic fiber is softened.

The cementitious material and the lignocellulosic fibers of the present disclosure are bone-dry. In some embodiments, a bone-dry weight ratio of the cementitious material covering the surface area of each of the lignocellulosic fibers to the lignocellulosic fiber is at least 1:1, at least 2:1, at least 3:1, at least 4:1, or at least 5:1. In some embodiments, the lignocellulosic fibers have a moisture content of less than 15%. In some embodiments, the lignocellulosic fibers have a moisture content of less than 30%, 25%, 20%, 19%, 18%, 17%, 16%, 15%, 14%, 13%, 12%, 11%, 10%, 9%, 8%, 7%, 6%, 5%, 4%, 3%, 2%, or 1%. In some embodiments, a weight ratio of the cementitious material covering the surface area of each of the lignocellulosic fibers to the lignocellulosic fiber is at least 1:1, at least 2:1, at least 3:1, at least 4:1, or at least 5:1.

In some embodiments, the densified engineered lignocellulosic composite comprises a coupling agent. The coupling agent of the present disclosure adheres the mineral powder to the surface area of the lignocellulosic fibers. In some embodiments, the coupling agent is an adhesive. In some embodiments, the adhesive is chosen from a monosaccharide, a disaccharide, a polysaccharide, a polyvinyl acetate, a cyanoacrylate, an ethylene vinyl acetate, a protein, an epoxy resin, a polyurethane, and an elastomer. In certain embodiments, the coupling agent is a polysaccharide such as starch or a protein. In some embodiments, the coupling agent is an “strong adhesive” or “strong tacking agent” that adheres tightly such that the mineral powder is difficult to remove from the lignocellulosic fibers. In other embodiments, the coupling agent is a “mild adhesive” or “mild tacking agent” that adheres lightly or loosely or mildly, such that the mineral powder adheres to the lignocellulosic fibers but with aggressive rubbing, some portions of the powder can be removed from the fibers. In some embodiments, the coupling agent is water. In some embodiments, the surface of lignocellulosic fibers is temporarily wetted with water so that the mineral powder adheres the mineral powder to the surface area of the lignocellulosic fibers.

The geometry of the densified engineered lignocellulosic composite may be controlled. In some embodiments, the densified engineered lignocellulosic composite is encapsulated in cementitious matrix. In some embodiments, the densified engineered lignocellulosic composite is arranged as a mat. The density of the densified engineered lignocellulosic composite may be controlled.

The composite may be used in various different types of products. For example, it may be issued to make siding to protect a home, in roofing tiles, in panel boards, in I-beams, in laminates, in poles and posts, in blocks, in trim, and various other construction materials building a home or other structure.

### 5.6. Precursor of Densified Engineered Lignocellulosic Composite

The densified engineered lignocellulosic composite may be prepared in several steps, each step including preparing a precursor of a densified engineered lignocellulosic composite. The precursors may include a coated lignocellulosic composite precursor (which includes coated lignocellulosic fiber precursors) and a cementitious composite precursor.

### Coated Lignocellulosic Fiber Precursor

In some embodiments, a coated lignocellulosic fiber is disclosed. The coated lignocellulosic fiber may further comprise a coupling agent. A coupling agent may be applied to the surface area of each of the lignocellulosic fibers, as presented in FIG. 2 in one example embodiment. The coupling agent generates a temporarily or lightly adhering layer on the surface area of the lignocellulosic fiber. In some embodiments, the coupling agent may lightly adhere to the surface, such as the surface of a lignocellulosic fiber or the surface of the mineral powder particle. As shown in FIG. 2, the lignocellulosic fiber 100 is coated with a layer of a coupling agent 120. The fiber may be entirely coated or may be coated up to some level or percentage, such as at least 99%, 98%, 95%, 90%, 88%, 85%, 80%, 78%, 75%, 70%, 65%, 60%, etc. In some embodiments, the lignocellulosic fibers are mostly coated, or coated greater than 50%. In some embodiments, the lignocellulosic fibers are substantially coated, or coated greater than 80%. In some embodiments, the fibers are highly coated, or coated greater than 95%. In addition, the fibers may be uniformly coated. In some embodiments, the fibers may be coated uniformly up to a level of at least 99%, 98%, 95%, 90%, 88%, 85%, 80%, 78%, 75%, 70%, 65%, 60%, etc. In some embodiments, the lignocellulosic fibers are mostly uniformly coated, or uniformly coated greater than 50%. In some embodiments, the lignocellulosic fibers are substantially uniformly coated, or uniformly coated greater than 80%. In some embodiments, the fibers are highly uniformly coated, or coated greater than 95%.

To apply the coupling agent 210, such as a tacking agent, it may be sprayed inside a cavity where the fiber is being constantly swirled or agitated. Droplets of the liquid coupling agent 120 may be formed in the air within the cavity to deposit on the fibers 100, and also the fibers 100 may transfer coupling agent 120 to other fibers 100 so they all get coated. In some embodiments, the lignocellulosic fibers 100 have regular or irregular geometry. Geometry may be uniform or non-uniform. The surface area pattern may be more complex or less complex. The coating may cover the fibers 100 irrespective of the fiber geometry. For example, the lignocellulosic fibers 100 can be made up of wood chips of different sizes and shapes, and/or fragments of wood chips, and or fibrous materials or interstitial capillaries. When a collection of lignocellulosic fibers is together in a container, the fibers may be made up of a multitude of shapes and sizes that can create differently sized pockets or areas within the lignocellulosic material. This presents an additional challenge when it comes to coating all of the surfaces of the lignocellulosic material because it can be difficult to get the mineral powder into all of the pockets and areas between these irregular shapes. In fact, the distribution of the outer surface areas of the material may be unknown or difficult to determine, yet it is still desirable to have the full surface area or substantially all of the surface area covered with the powder. The methods described herein however address this problem by providing a mechanism to apply the powder to all or substantially all of the surfaces regardless of the irregularity in the lignocellulosic material that is present.

The coated lignocellulosic fiber may further comprise a layer of mineral powder particles adhered to the adhering layer of the coupling agent. The first layer forms a substantially uniform coating covering the lignocellulosic fiber, as presented in FIG. 3, according to an example embodiment. As shown in FIG. 3, the lignocellulosic fiber 100 is coated with a layer of a coupling agent 120, on top of which the first layer of mineral powder particles 130 is adhered. The particles are loosely adhered or are reversibly or temporarily adhered, in some embodiments. The mineral powder may be deposited onto the fibers by putting the mineral powder into a carrier, such as carrier agent 160 in FIG. 6, which presents the powder as a different density, such as a density similar to the fiber density. The fiber may be entirely coated with powder by the carrier 160 or may be coated up to some level or percentage, such as at least 99%, 98%, 95%, 90%, 88%, 85%, 80%, 78%, 75%, 70%, 65%, 60%, etc.

In some embodiments, one or more additional layers of the mineral powder particles may be applied to the first layer. The additional layers may be formed by combining a layering agent with the powder that allows the particles of the powder to be at least partially coated (or substantially or entirely coated) with the layering agent. This makes the particles themselves such that they can loosely or temporarily adhere to the layer of powder that is already on the fibers to form a second layer (or a third or fourth layer, etc.). This allows the additional layers to be applied as a substantially uniform coating around the first layer on each of the lignocellulosic fibers, as presented in FIG. 4. As shown in FIG. 4, the lignocellulosic fiber 100 is coated with a layer of a coupling agent 120, on top of which the mineral powder particles 130 are adhered. The first layer of mineral particles 130 is coated with a layer of a layering agent 140, on top of which a second layer of mineral powder particles 130 may be adhered, if desired. The one or more additional layers encasing the first layer can make a thicker layer of powder, thus affecting the final properties of the densified composite.

In some embodiments, the mineral particles of additional layers are themselves encased or encompassed in a layering agent 150 that is adhering or adhesive. In some embodiments, the layering agent 150 surrounds the mineral powder particles 130 by being contained within a carrier, such as carrier agent 160 (e.g., a liquid, gas, foam, etc.) in FIG. 6 that holds the layering agent 150 on the mineral powder particles 130. This layering agent 150 allows the particles to themselves be able to adhere to other surfaces, such as to the surface of the mineral powder coated fiber. The layering agent can be any layer or form of adherence, including but not limited to an adhesive (e.g., glue, cement, paste, epoxy, polyurethane, spray glue, etc., adherence by hydrostatic forces, by hydrodynamic forces, by covalent chemical bonding, by intermolecular forces, by cohesion etc.).

In some embodiments, the layering agent is an adhesive. In some embodiments, the coupling agent is an adhesive. The adhesive may be chosen from a monosaccharide, a disaccharide, a polysaccharide, a polyvinyl acetate, a cyanoacrylate, an ethylene vinyl acetate, a protein, and an elastomer.

In some embodiments, the additional layers of mineral powder particles are deposited on the fiber via a carrier agent 160, such as that shown in FIG. 6. However, other forms of deposition may be used.

### Coated Lignocellulosic Composite Precursor

In some embodiments, a coated lignocellulosic composite precursor is disclosed. The coated lignocellulosic composite precursor may comprise a plurality of lignocellulosic fibers (e.g., from 2 to millions of coated lignocellulosic fiber precursors), such as the coated fibers described in the prior section of this disclosure. The coated lignocellulosic composite precursor may be made up of a large number of these fibers. In some embodiments, the lignocellulosic fibers are wood fibers.

Similar to the single coated fiber precursor, the coated lignocellulosic composite precursor may comprise a coupling agent. The coupling agent 120 may be applied to the outer surface area of each of the lignocellulosic fibers. The coupling agent 120 may generate an adhering layer on the outer surface area of the lignocellulosic fibers 100. In some embodiments, the coupling agent 130 is an adhesive. In some embodiments, the adhesive is chosen from a monosaccharide, a disaccharide, a polysaccharide, a polyvinyl acetate, a cyanoacrylate, an ethylene vinyl acetate, a protein, an epoxy resin, a polyurethane, and an elastomer. The adhesive may be a monosaccharide, a disaccharide, a polysaccharide, or a protein.

The coated lignocellulosic composite precursor may comprise a plurality of mineral powder particles 130. The plurality of mineral powder particles 130 may form a substantially uniform coating on the surface area of each of the lignocellulosic fibers 100.

In some embodiments, a layering agent 140 allows more powder layers to be added. In certain embodiments, there is also a layering agent 150 that is temporarily or lightly adhered to the surface area of each of the plurality of mineral powder particles. In some embodiments, the layering agent 140, 150 is used for applying one or more additional layers of substantially uniform coating of the mineral powder particles 130 to the surface area of each of the lignocellulosic fibers 100. In some embodiments, the layering agent 140, 150 is an adhesive. In some embodiments, the adhesive is chosen from a monosaccharide, a disaccharide, a polysaccharide, a polyvinyl acetate, a cyanoacrylate, an ethylene vinyl acetate, a protein, an epoxy resin, a polyurethane, and an elastomer. The adhesive may be a monosaccharide, a disaccharide, a polysaccharide, or a protein. In some embodiments, the layering agent is an “strong adhesive” or “strong tacking agent” that adheres tightly to the mineral powder such that it is difficult to remove from the mineral powder. In other embodiments, the layering agent is an “mild adhesive” or “mild tacking agent” that adheres lightly or loosely or mildly, such that it adheres to the mineral powder but with friction, some portions can be removed from the powder.

In some embodiments, the coated lignocellulosic composite precursor comprises mineral powder particles 130. The mineral powder particles 130 may be magnesium oxide particles. In some embodiments, the plurality of mineral powder particles 130 and/or lignocellulosic fibers 100 is treated with a spray. In some embodiments, the spray may include an aqueous liquid. In some embodiments, the spray may include a non-aqueous liquid.

In some embodiments, the plurality of mineral powder particles 130 and/or lignocellulosic fibers 100 is treated with a carrier 160, such as a liquid, a gas, a spray gas, a spray liquid, a chemical compound, a slurry, a foam, a combination thereof, or other component. This carrier may be presented as an intermediate suspension that carries the powder. The suspension may include an adhesive or a material designed to provide adhering force or to provide tackiness. As one example, it may include a foaming agent and may include water. The intermediate suspension may be transient or have a transient form and may only exist for a period of time or may only exist in a particular form (e.g., as a foam or a gas or a spray gas) for a period of time. In some embodiments, the carrier (e.g., foam) comprises at least 1%, at least 2%, at least 3%, at least 4%, or at least 5% of a carrier agent (e.g., foaming agent). Examples of foaming agents include, but are not limited to, chemical gas generators like azodicarbonamide, sodium bicarbonate, aluminum powder, and hydrogen peroxide, as well as physical agents such as nitrogen, carbon dioxide, and hydrocarbons. In some embodiments, the carrier (e.g., foam) comprises 2 to 5% of a carrier agent (e.g., foaming agent). In the foam example, the foam application of powder is a transient process where there is a limited window of time from foam formation to collapse of the foam. The foam creates a false volume or a suspension. The bubbles form because there is enough surface tension.

Since the fibers are dry, they start to absorb water out of the foam and start to break down the foam, which provides a secondary mechanism for bringing the powder onto the fiber. The liquid is pulled into the dry fiber, leaving the powder on the surface of the fiber. The wall of the fiber acts as a filter that water can pass through, but powder is left behind to sit on top of the fiber.

The geometry of the coated lignocellulosic composite precursor may be controlled. Making a precursor with very fine fiber (100 μm and less) is harder than with different types of fibers combined. In some embodiments, the fibers are first screened into fine fibers (100 μm and less) and coarse fibers (100 μm and more). Wood particles still generally have hairs protruding from the particles and have numerous different shapes. It is very hard to cover the surface of all of the shapes. The carrier can spread the powder inside of it under each hair and every shape so covers the total surface after mixing. Any type of carrier can be used, including, but not limited to, liquid, gas, a spray-liquid, spray-gas, aerosol, aerogel, mineral, paper, powder, dye, rubber, ceramic, plastic, textile, chemical, stone, plaster, fiber, composite, glass, foam, fluid, alloy, polymer, biomaterial, crystal material, superalloy, slurry, adhesive, etc. The carrier may be an intermediate suspension designed to carry the powder for coating the irregular surfaces of the lignocellulosic fibers, including by entering all of the pockets and crevices between the chips and hairs and fragments that may make up the lignocellulosic material. An even coating can be provided on all of the surfaces despite the irregularity of the material and even if the distribution of the outer surface areas of the material is unknown or hard to determine. There will be variations in the process and components used to make the precursor based on the different engineered product being made.

Now that the lignocellulosic material is coated (fibers, wood chips, hairs, fragments, etc.), this material can be handled easily without sticking to itself. Any coupling agent is covered with mineral powder so the material or fibers are not sticky. These can be placed in machinery for further processing, transported to another facility, etc. The fibers are also now prepared for addition of cement-forming additive at any time, unlike prior methods where the three components, fibers, mineral, and cement-forming additive were mixed at once that provided uneven results. Also simply mixing mineral powder and fibers does not result in coated fibers without the methods described here.

### Cementitious Composite Precursor

In some embodiments, a cementitious composite precursor is disclosed. The cementitious composite precursor may comprise a coated lignocellulosic composite precursor and a cement-forming additive 190, such as is show in FIGS. 8a and 8b. The mineral powder reacts with the cement-forming additive to form a substantially uniform layer of the cementitious material on the surface area of the coated lignocellulosic fibers. In some embodiments, the cement-forming additive is an inorganic salt. In some embodiments, the inorganic salt is ammonium polyphosphate. The ammonium polyphosphate may be in a liquid form.

In certain embodiments, the mineral powder comprises magnesium oxide (MgO) and the cement-forming additive comprises an acid phosphate source, such as ammonium polyphosphate. Upon contact in the presence of water, the MgO is hydrated to magnesium hydroxide Mg(OH)₂, which subsequently reacts with the phosphate species to form an insoluble magnesium oxyphosphate cement matrix. The overall reaction generates hydrated phosphate complexes, such as MgKPO₄·6H₂O or NH₄MgPO₄·6H₂O, depending on the specific phosphate salt and stoichiometry employed. The cementitious reaction proceeds rapidly at ambient or mildly elevated temperatures, producing a dense, dimensionally stable, and high-strength binding phase that encapsulates and bonds to the lignocellulosic fibers.

Lignocellulosic fibers may be coated with mineral powder particles. The same conditions described above for the coated lignocellulosic fiber precursor and the coated precursor composite may also apply to the fibers in this cementitious precursor.

In some embodiments, the lignocellulosic fibers are positioned in a substantially uniform arrangement as a mat 180, such as is shown in FIG. 7 and in FIGS. 8a and 8b. This arrangement may be formed in various ways. For example, the fibers may fall onto a conveyor belt or platform in an aligned fashion to be formed into a mat. FIG. 8b illustrates fibers 170 falling onto and forming a mat 180

The mat 180 comprises a plurality of layers comprising the lignocellulosic fibers. The surface area of each of the lignocellulosic fibers is coated with mineral powder particles. In some embodiments, lignin of the lignocellulosic fibers is temporarily softened by an in situ generated softening agent. In some embodiments, the softening agent is ammonia. In certain embodiments, the in situ generated softening agent is an in situ generated ammonia released on the surface area of each of the lignocellulosic fibers. In certain embodiments, the in situ generated ammonia is released when the magnesium oxide particles react with the ammonium polyphosphate to form magnesium phosphate cement, which is the cementitious material and water.

In embodiments utilizing ammonium polyphosphate, the reaction may liberate ammonia (NH₃) into the aqueous phase. This in-situ generated ammonia can act as a temporary softening agent, permeating lignocellulosic cell walls and enabling plastic deformation, densification, and enhanced penetration of the cementitious phase. Removal of the ammonia during a subsequent heat-curing step restores the rigidity of the fiber structure while the magnesium oxyphosphate matrix continues to harden to full strength.

The mat 180 may also comprise the liquid containing the cement-forming additive 190. This may be added to the mat 180 after it is already formed (FIG. 8a) or while it is being formed (FIG. 8b). For example, if the mat 180 is formed on a platform or a conveyor belt, the additive 190 can be poured, sprayed, or otherwise deposited onto the mat. FIG. 8a illustrates pouring but this is also intended to encompass a spraying mechanism or other mechanisms of deposition. The additive 190 can be deposited onto the mat once it is completely formed on the conveyor belt or as it is being formed while it moves along the conveyor belt, such as while additional layers of fibers are being added. As another example, the cement-forming additive 190 can be added to the fibers before they are formed into the mat, such as immediately before they reach the conveyor belt or as they fall onto a mat being formed on a conveyor belt. The fibers may, for example, be sprayed with cement-forming additive 190 as they are falling onto the conveyor belt. Other methods of depositing additive 190 on the fibers as they are falling onto the conveyor belt or platform may also be used. FIG. 8b illustrates cement-forming additive 190 being sprayed onto falling coated lignocellulosic fibers 170 that are forming a mat 190. In some embodiments, the cement-forming additive 190 is ammonium polyphosphate.

The geometry of the cementitious composite precursor can be controlled. In some embodiments, the mat of lignocellulosic fibers is positioned on equipment for forming and densifying the densified engineered lignocellulosic composite.

### 5.7. Methods of Preparing Densified Engineered Lignocellulosic Composite Precursors

The methods for preparing the densified engineered lignocellulosic composite precursors of the present disclosure are described herein. These steps of each of the methods can occur in different orders and there may be more, fewer, or different steps than stated.

### Method of Preparing a Coated Lignocellulosic Composite Precursor

A coated lignocellulosic composite is a precursor in the preparation of the densified engineered lignocellulosic composite. Preparing a coated lignocellulosic composite involves coating the surface of lignocellulosic fibers with a coupling agent, such as an adhesive and applying at least one layer of mineral powder particles to the coupling agent layer or adhesive layer. In some embodiments, the fibers are dried to prepare them to be used as a precursor. The moisture content (MC) of the fiber is based on dry fiber. In some embodiments, the fibers are not dried. In some embodiments, the lignocellulosic fibers have a moisture content of less than 15%. In some embodiments, the lignocellulosic fibers have a moisture content of less than 30%, 25%, 20%, 19%, 18%, 17%, 16%, 15%, 14%, 13%, 12%, 11%, 10%, 9%, 8%, 7%, 6%, 5%, 4%, 3%, 2%, or 1%.

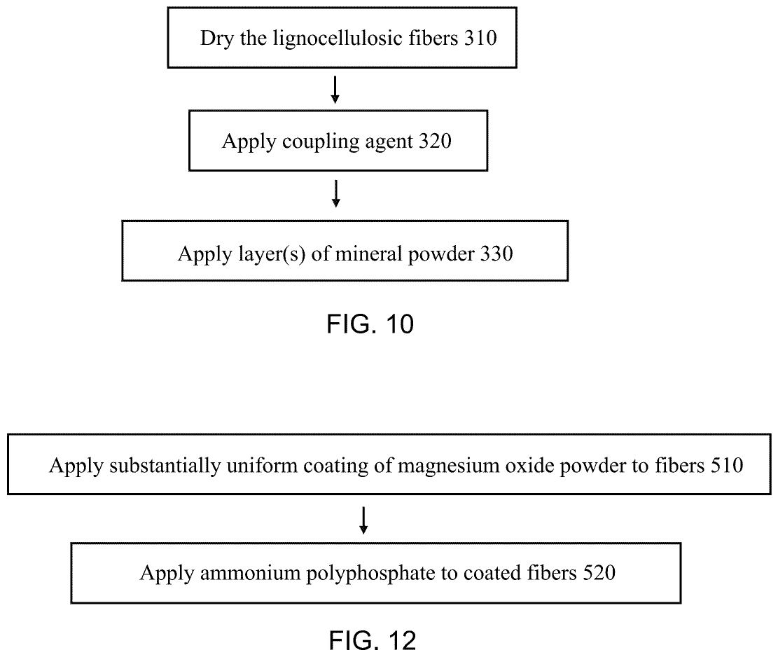

FIG. 10 is a flow chart illustrating one embodiment of a method of preparing a coated lignocellulosic composite precursor. First, the lignocellulosic fibers may be dried 310 to prepare them to be used as a precursor. Next, a coupling agent is applied 320 on a surface area of a plurality of lignocellulosic fibers. The coupling agent generates a temporarily or loosely adhering layer on the surface area of each of the lignocellulosic fibers. In one example, these fibers are placed into a mat, and the adhesive is poured, sprayed, dropped, or otherwise deposited onto the fibers. In another example, the fibers are spread onto a conveyor belt, and the adhesive is poured, sprayed, dropped, or otherwise deposited onto them.

Second, a layer of mineral powder particles is applied (330) to the coupling agent. In some embodiments, the mineral powder particles are magnesium oxide particles. The layer is applied as a substantially uniform coating around each of the lignocellulosic fibers.

The mineral powder may be added by spraying the powder onto the fibers in a liquid or in a gas form, by placing the fibers into a vat of mineral powder, by soaking the fibers in a liquid containing mineral powder, by placing the fibers in an enclosed area where mineral powder is aerosolized to deposit on the fibers, by placing the fibers in a mineral powder slurry, etc.

In some embodiments, this coupling agent is sufficient to allow the lignocellulosic fibers to be entirely coated with a uniform or substantially uniform coating of mineral powder. In other embodiments, the coupling agent allows the powder to adhere to the surface of the fibers, but it still will not form a uniform coating or it may form a uniform coating but not meet the desired thickness. To address the different densities of the fibers and the powder, in this instance, the powder may be added to a carrier or carrier agent (e.g., liquid, gas, a spray-liquid, spray-gas, aerosol, aerogel, mineral, paper, powder, dye, rubber, ceramic, plastic, textile, chemical, stone, plaster, fiber, composite, glass, foam, fluid, alloy, polymer, biomaterial, crystal material, superalloy, slurry, adhesive, etc.) that acts as an intermediate suspension that neutralizes the difference in the density of the powder and the bulk-density of the fibers. Alternatively, the carrier can be mixed with a coupling agent prior to the addition of other ingredients. In some embodiments, dry ingredients, such as mineral powder and lignocellulosic fibers, can be added to the mixture of a carrier and a coupling agent. In some other embodiments, the mixture of a carrier and a coupling agent can be added to the premixed combination of mineral powder and lignocellulosic fibers. In some embodiments, lignocellulosic fibers can be added to the mixture of a carrier, a coupling agent, and mineral powder.

In a first embodiment, the carrier is a gas, and the powder is distributed in the gas while fibers are in contact with the gas. The powder in the gas then comes into contact with the fibers and is deposited on the fibers. Because the gas can enter all of the crevices of the fibers, the powder is deposited on all of the surfaces in a substantially uniform coating.

In a second embodiment, the carrier is a spray-gas, and the powder is sprayed onto the fibers. The spray is designed to access all surfaces of the fibers such that the fibers are well coated with the powder in a substantially uniform coating. In some embodiments, an aerosol comprising a coupling agent is continuously sprayed on the mineral powder, followed by the addition of lignocellulosic fibers and subsequent agitation.

In a third embodiment, the carrier is a liquid. The fibers are dipped in the liquid that holds the powder and when the fibers are lifted out of the liquid, the powder adheres to the liquid. In some cases, the powder must be pre-treated to ensure that the powder will stick to the fibers when lifted from the liquid in a substantially uniform coating. In some embodiments, the fibers are dipped into the mixture of liquid, coupling agent, and mineral powders to ensure even spreading of the mineral powder particles over a total surface of each of the plurality of lignocellulosic fibers.

In a fourth embodiment, the carrier is a spray liquid, and the powder is sprayed onto the fibers. The spray is designed to access all surfaces of the fibers such that the fibers are well coated with the powder in a substantially uniform coating.

In a fifth embodiment, the carrier is a slurry, and the powder is placed into the slurry that is designed to allow the powder to cover the fibers and stick to the fibers to coat them in a substantially uniform manner.

In a sixth embodiment, a chemical adherence method is used as a carrier to adhere the powder directly to the fibers and coat the fibers on all surfaces in a substantially uniform manner.

In a seventh embodiment, the carrier is a transient material, such as a foam, that has a particular form for a period of time but then changes form (e.g., the foam becomes a liquid that may be absorbed into the fibers). For example, the mineral powder may be dispersed within the foam. Or the carrier suspends the powder on its surface or on the surfaces of its components (e.g., on small bubbles or other sub-components) at the scale of the fibers and so allows the powder to be deposited on the fibers as a uniform or substantially uniform coating surrounding or covering the surface area fibers after mixing. The lignocellulosic fibers are subsequently added to the mixture of the foam plus powder particles, or the foam with particles is added to the fibers. In some embodiments, the lignocellulosic fibers are agitated with the foam at high shear for even spreading of the plurality of mineral powder particles over a total surface of each of the plurality of lignocellulosic fibers.

Alternatively, the powder may also be deposited on the fibers by spraying or rubbing against each other in a high-shear mixer.

Third, in some embodiments, additional layers 330 of mineral powder particles may be applied to the first layer. For example, the mineral powder particles of the layers may comprise a layering agent that allows the additional layers to be applied as a substantially uniform coating around the first layer on each of the lignocellulosic fibers. Since the fibers are now covered with a first layer of powder such that more powder will not adhere to the fibers, a layering agent can be added on top of the layer of powder that is already present on the fiber to coat the surface area of the layer of powder. The layer agent can be designed to make them able to adhere or make the powder layer tacky or adhering on its outer surface or surface area. The layering agent may be the same or different from the coupling agent. The powder particles can then be added deposited on the powder coated fibers. The powder particles may be deposited in the same manners that were described above for depositing powder particles onto the uncoated fiber. For example, the coated powder particles may be sprayed onto the coated fibers.

Another example of a way to add additional layers of powder may include using a layering agent to encompass the powder particles themselves. The layering agent may be the same or different from the layering agent described above and/or the coupling agent. The coating of the layering agent around the powder particles allows them to adhere to the layer of powder particles already adhered to the fiber. The layering agent may be added to the powder particles in the same manner described above for adding the layering agent to the fiber, such as by spraying onto the powder, by applying using a carrier, etc. For example, the layering agent could be applied to the powder using a transient carrier, such as a foam, that deposits the layering agent on the powder particles.

The coated powder particles may themselves then be added to the coated fibers in any of the methods described above. For example, they may be sprayed or added to a carrier to be deposited on the already powder-coated fibers to add one or more additional powder layers. The process then can be repeated until the desired powder to fiber loading is achieved.

In embodiments, the mineral powder particles and the lignocellulosic fibers of the coated lignocellulosic composite are bone-dry. In some embodiments, a bone-dry weight ratio of the mineral powder particles to the lignocellulosic fibers is at least 1:1, at least 2:1, at least 3:1, at least 4:1, or at least 5:1. In some embodiments, the lignocellulosic fibers have a moisture content of less than 15%. In some embodiments, the lignocellulosic fibers have a moisture content of less than 30%, 25%, 20%, 19%, 18%, 17%, 16%, 15%, 14%, 13%, 12%, 11%, 10%, 9%, 8%, 7%, 6%, 5%, 4%, 3%, 2%, or 1%. In some embodiments, a weight ratio of the mineral powder particles to the lignocellulosic fibers is at least 1:1, at least 2:1, at least 3:1, at least 4:1, or at least 5:1.

In some embodiments, a mixer can be used to prepare a coated lignocellulosic composite.

### 5.8. Methods of Preparing a Densified Engineered Lignocellulosic Composite

The methods for preparing the densified engineered lignocellulosic composite of the present disclosure are described herein.

Preparing a densified engineered lignocellulosic composite involves several steps. A coated lignocellulosic composite precursor is prepared following the method described herein.

Further, a cement-forming additive, such as, for example, ammonium polyphosphate, is added to the coated lignocellulosic composite precursor. Afterwards, the mixture of a coated lignocellulosic composite precursor and a cement-forming additive may be positioned in a mat, which is further compressed to form the densified engineered lignocellulosic composite.

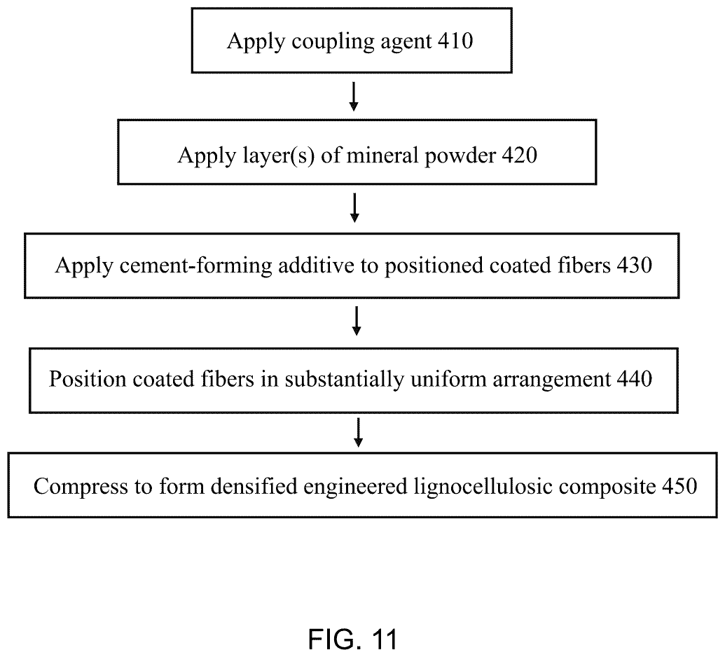

FIG. 11 is a flow chart illustrating one embodiment of a method of preparing a densified engineered lignocellulosic composite. First, a coated lignocellulosic composite precursor is prepared. The coated lignocellulosic composite precursor may comprise a plurality of lignocellulosic fibers. This includes applying 410 a coupling agent on a surface area of the lignocellulosic fibers to generate an adhering layer, and applying 420, to the adhering layer, a first layer of a plurality of mineral powder particles (e.g., metal oxide particles, such as magnesium oxide particles) as a substantially uniform coating around each of the lignocellulosic fibers.

Then, a cement-forming additive may be applied 430 to the surface area of each of the plurality of coated lignocellulosic fibers. The additive may be applied by pouring, spraying, spritzing, dropping, gravity deposition, or any other mechanism for applying a cement-forming additive. The additive may be added to stationary fibers, fibers falling onto a mat or conveyor belt, or fibers moving on a conveyor belt.

Next, the coated lignocellulosic composite precursor may be positioned 440 in a substantially uniform arrangement as a mat. This positioning may occur at the same time that the cement-forming additive is being applied 430, since the falling fibers may be being sprayed 430 with additive while the forming or positioning 430 is occurring. This positioning may occur manually or using machinery designed to position the fibers in a particular manner. For example, the fibers may pass through machinery that separates the fibers into layers and/or that arranges the fibers so that they are substantially parallel to one another. The machinery may also arrange them in a substantially uniform or organized manner. They may be positioned as a mat or in any other format that prepared them for formation into a composite product. They can be positioned on a conveyor belt and be moving for the next step that involves the addition of the cement-forming additive. Steps 430 and 440 can also occur in the opposite order where the fibers are first positioned 440 and then the additive is applied 430.

In some embodiments, the cement-forming additive is an inorganic salt (e.g., ammonium polyphosphate, such as in liquid form). In some embodiments, the plurality of lignocellulosic fibers is softened by an in situ generated softening agent, such as in situ generated ammonia that may be released when magnesium oxide reacts with ammonium polyphosphate to form magnesium phosphate cement. When the cement-forming additive reacts with the mineral powder particles, a cementitious material is generated.

Then, the lignocellulosic fibers and the cementitious material may be compressed 450 to form the densified engineered lignocellulosic composite. The compression may occur using machinery designed to compress the fibers from one or two sides. For example, a press may come down from above to press fibers layer on a platform. The compression will occur at the right time while the cementitious material can still be molded, such as when it is still in liquid or semi-liquid form.

The cementitious material and the lignocellulosic fibers of the present disclosure are bone-dry. In some embodiments, a bone dry weight ratio of the cementitious material covering the surface area of each of the lignocellulosic fibers to the lignocellulosic fiber is at least 1:1, at least 2:1, at least 3:1, at least 4:1, or at least 5:1. In some embodiments, the lignocellulosic fibers have a moisture content of less than 15%. In some embodiments, the lignocellulosic fibers have a moisture content of less than 30%, 25%, 20%, 19%, 18%, 17%, 16%, 15%, 14%, 13%, 12%, 11%, 10%, 9%, 8%, 7%, 6%, 5%, 4%, 3%, 2%, or 1%. In some embodiments, a weight ratio of the mineral powder particles to the lignocellulosic fibers is at least 1:1, at least 2:1, at least 3:1, at least 4:1, or at least 5:1. The same features of the lignocellulosic fibers described above may apply here too.

The geometry of the densified engineered lignocellulosic composite may be controlled. In some embodiments, the lignocellulosic fibers of the coated lignocellulosic composite may be positioned in a substantially uniform arrangement as a mat. In some embodiments, the mat of lignocellulosic fibers is positioned on equipment for forming densified engineered lignocellulosic composite.

The excess of the in-situ generated ammonia may be removed. In some embodiments, the method comprises heating the cementitious material to at least 105° C. up to 160° C. to remove excess of the in-situ generated ammonia. In some embodiments, the in-situ generated ammonia is recaptured and reused.

### 5.9. Methods of Generating In Situ Softening Agent

The use of anhydrous, gaseous, or aqueous ammonia (NH₃) to soften lignocellulosic materials is known in industry and was studied for its abilities to affect the lignin and the hemicellulose cross-linking in ligneous materials. However, the research focuses solely on the external sources of ammonia for wood softening or solubilization.

A method of an internal, in-situ generated, ammonia for softening lignocellulosic fiber, such as wood fiber, is disclosed herein. The in-situ generated ammonia as a byproduct of the main reaction between the substances producing the cement, dissolves in the available water and reacts with the lignocellulosic material. The lignocellulosic material treated with liquid aqueous ammonia becomes soft and it is said to be plasticized. Moreover, the ammonia provokes the dissolution of xylose and glucose monomers (low-molecular lignocellulosic saccharides) as well as the arabinogalactans (higher-molecular components of cellulose, hemicellulose, and lignin). This phenomenon allows lignocellulosic materials to lose a part of its internal cohesion, allowing the constituent fiber bundles to slide easier in relation to each other. Once the softening agent (ammonia) is removed, new bonds are established between the fibers. The ammonia may be removed by means of a heat treatment in excess of 150° C. and is captured through vapor condensation as an aqueous solution. In some embodiments, the in-situ generated ammonia is recovered for reuse. The aqueous ammonia solution may be returned for the reuse in the process creating a circular ammonia economy.

In certain embodiments, a densified engineered lignocellulosic composite is produced from a composition comprising a lignocellulosic material, such as a heterogeneous mixture of lignocellulosic fibers, wood chips, particles, shavings, or other plant-derived fibrous matter of varied geometries; a mineral powder, such as magnesium oxide (MgO); and a cement-forming additive, such as ammonium polyphosphate (APP).

NH₃ is produced in-situ when the ammonium polyphosphate (APP) reacts with magnesium oxide to form a ceramic/cementitious hydrated crystalline matrix called magnesium oxyphosphate ceramic/cement. The major reaction products develop at room temperature and were found to be ternary phases of NH₄MgPO₄·6H₂O and Mg₃(PO₄)₂·4H₂O hydrated crystals. This reaction liberates ammonia gas (NH₃) as a by-product. The NH₃ dissolves readily into the available water to form aqueous ammonia, which permeates the lignocellulosic cell walls. The aqueous ammonia plasticizes the fibers by disrupting hydrogen bonding between cellulose molecules; interacting with lignin to increase chain mobility; dissolving low-molecular saccharides (xylose, glucose) and higher-molecular arabinogalactans from the hemicellulose-lignin network; and reducing internal cohesion so that fiber bundles can slide relative to each other. As a result, the lignocellulosic component temporarily loses stiffness, enabling reconfiguration and high-pressure densification without fracture.

FIG. 12 is a flow chart illustrating a method of generating in situ softening agent on coated lignocellulosic fibers according to an embodiment. First, a substantially uniform coating of magnesium oxide powder particles is applied 510 to a plurality of lignocellulosic fibers. In some embodiments, the lignocellulosic fibers have been treated with a coupling agent on a surface area to form the coated lignocellulosic fibers. Second, ammonium polyphosphate is applied 520 to the coated lignocellulosic fibers. The ammonium polyphosphate reacts with the coating of magnesium oxide powder particles to generate in situ ammonia on the surface area of each of the lignocellulosic fibers as a softening agent.

In some embodiments, ammonium polyphosphate is in a liquid form. In some embodiments, ammonium polyphosphate is applied by spraying onto the lignocellulosic fibers, wherein each of the lignocellulosic fibers has a substantially uniform coating of magnesium oxide powder particles. In some embodiments, the in situ ammonia is generated as a softening agent on the outer surface area and inside of each of the lignocellulosic fibers and their interstitial capillaries.

### 6. EXAMPLES

The examples and preparations provided below further illustrate and exemplify the densified engineered lignocellulosic composite as disclosed herein and methods of preparing such composites. It is to be understood that the scope of the present disclosure is not limited in any way by the scope of the following examples and preparations.

The following abbreviations have the definitions set forth below:

| | |
|---|---|
| MC | Moisture content |
| MgO | magnesium oxide |
| CO₂ | carbon dioxide |
| MOP | magnesium oxy phosphate |
| ApP | ammonium polyphosphate |
| SGW | stone ground wood |
| PSW | pressure ground wood |
| RMP | refiner mechanical pulp |
| TMP | thermomechanical pulp |
| CTMP | Chemi-thermo-mechanical pulp |
| RH | relative humidity |
| NH₃ | Ammonia |

### 6.1. Example 1. General Procedure for Preparing a Densified Engineered Lignocellulosic Composite

The described densified engineered lignocellulosic composite is made from three main ingredients: lignocellulosic fibers (which may be a heterogeneous mix of fibers, wood chips, and varied shapes with crevices), mineral powder such as magnesium oxide (MgO), and a cement-forming additive like ammonium polyphosphate.

In preparation, the lignocellulosic fibers are softened for example, chemically with ammonia to alter their structure, making the fibers easier to compress and densify into an engineered wood product.

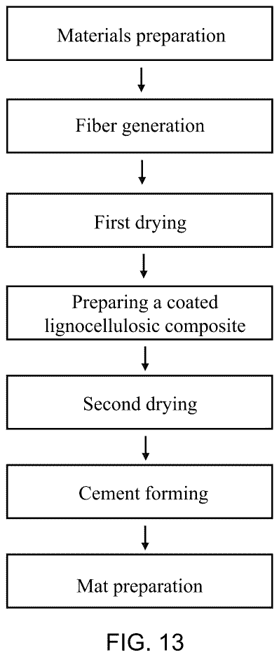

An exemplary overall method for preparing a densified engineered lignocellulosic composite is illustrated on FIG. 13 and outlined below.

### Materials Preparation

1. The commercially available lignocellulosic fiber chips, such as spruce, pine and fir, with dimensions in the range of 1″×½″×¼″ are provided.
2. The lignocellulosic fiber chips are reduced in size to a fiber target size of ½×⅛× 1/24 inches.

### Fiberization

The lignocellulosic fiber chips are fiberized by different methods (flaking, grinding, refining) to achieve the desired fiber shape slenderness ratio (i.e. a ratio between length/diameter of typically 60 to 120) in accordance with end product.

### First Drying

The lignocellulosic fiber is dried to MC 12-15%.

### Preparing a Coated Lignocellulosic Composite

### Method 1

1. The lignocellulosic fibers are coated with a coupling agent.
2. The foam is generated. Mineral powder (such as MgO) is dispersed within the foam.
3. Mineral powder is deposited over the fibers by mixing the fibers with the foam.
4. Optionally, a coupling agent is added to the foam to allow for an increased deposition of powdered mineral.
5. The lignocellulosic fiber is mixed with minerals and optional other additives to adhere powder to the fiber. FIG. 1 illustrates an exemplary coated lignocellulosic composite.

### Method 2

The foam can be mixed with a coupling agent prior to the addition of other ingredients. Three exemplary options of adding other ingredients to the mixture of foam and a coupling agent are outlined below.
1. Dry ingredients (mineral powder and fibers) can be added to the mixture of foam and a coupling agent.
2. The mixture of foam and a coupling agent can be added to the premixed combination of mineral powder and fibers.
3. Fibers can be added to the mixture of foam, a coupling agent, and mineral powder.

The mixture is afterwards mixed until the fibers have absorbed the water from the foam. The coupling agent in the foam is now evenly dispersed over the total surface of the powder and the fiber.

### Method 3

Alternatively, the mineral powder is added to the foam containing the coupling agent, followed by the addition of fibers and subsequent mixing.

### Second Drying

The mixture is dried to −8-12% MC (in relation to the dry weight of the mixture) level to remove excess moisture. The desired moisture level must be in equilibrium with the fiber portion in the mixture and should not exceed the absolute bound water holding capacity of the wood.

### Metering and Mat Forming

1. The coated lignocellulosic composite is fed into the feed bin and metered out at a desired flow over the full width of the machine.
2. The flow is then directed into the primary Flow Splitter and separated into two equal streams (50/50%).
3. The separated streams are directed then to two secondary Flow Splitters and separated into four equal streams (25/25/25/25%).
4. Each of the four streams is deposited successively, one over the other onto the moving forming conveyor and the original material flow is reconstituted into a highly uniform mat.

### Cement Forming

1. The cement forming liquid is atomized through airless, hydraulic nozzles to cover the powder coated wood fibers during the deposition onto the moving conveyor into a continuous mat.
2. During the forming of the mat, the liquid is sprayed on the falling fiber from two sides. The amount of the liquid is in ratio with the amount of powder adhered to the fiber and the specific surface of the furnish.

### Mat Pressing

1. The mat with the mixed ingredients enters a double belt press, where the material is compressed to a predetermined thickness under pressure. The material is maintained in its final dimensional form until the exothermal reaction temperature rises up to 70-90° C.

Afterwards, the board/product has developed enough strength and can be handled and placed in the curing/drying oven.

Alternatively, the coated lignocellulosic composite is dosed through a former where an even amount of precoated fiber is going to be deposited on a moving belt. Before the falling, precoated fibers land on the belt to form an even layer, while the cement forming liquid is sprayed on the falling fibers. The precoated fibers with the cement forming liquid already on the fiber surface, are formed into a substantially uniform arrangement within the mat.

### 6.2. Example 2. Methods of Preparing a Coated Lignocellulosic Composite

Prior techniques failed to uniformly and reproducibly coat lignocellulosic fibers with fast-setting cementitious material. Therefore, a uniform, reproducible mixture of lignocellulosic fibers, magnesium oxide (MgO), and ammonium polyphosphate could not have been produced. When these three components are mixed directly, the cementitious material starts hardening within seconds, leaving too little time to properly mix and densify the material. As a result, prior methods fail to achieve an even coating of cementitious powder over the entire surface area of each fiber or wood chip in the mix. Direct mixing typically leads to non-uniform coatings and inconsistent composite quality. This problem has been solved through various techniques disclosed herein.

Exemplary methods for preparing a coated lignocellulosic composite are outlined below. FIG. 1 illustrates an exemplary coated lignocellulosic composite.

The coated lignocellulosic composite contains fiber, powdered minerals, coupling agent, foaming agent, and water.

### Method 1

### General Procedure

1. The fibers are dried to prepare them to be used as a precursor. The lignocellulosic fiber is dried to a MC of 12-15%, based on dry fiber. The powder can be magnesium oxide (MgO) or a blend thereof with a pigment.
2. The water based coupling agent is atomized in the turbulent environment of a mixer, creating an aerosol.
3. The aerosol containing a coupling agent is continuously sprayed on the powdered mineral (MgO).
4. The fibers are added to the resulting powdered mineral sprayed with a layer of coupling agent.
5. The resulting mixture of fibers and the powdered mineral sprayed with a layer of coupling agent is agitated at high shear for even spreading of the mineral powder particles over a total surface of each of the plurality of lignocellulosic fibers. The coupling agent allows the fibers to be entirely coated with a uniform or substantially uniform coating of mineral powder. Optionally, a mixer, such as tumble mixer, can be used for continuous mixing of the ingredients.
6. Additional layers of MgO particles may be applied to the first layer during the agitation of the foam containing the coupling agent, the dispersed MgO powder, and the fibers. The coupling agent allows the MgO particles to adhere or make the powder layer tacky or adhering on its outer surface or surface area. As a result, the powder particles can then be deposited on the powder coated fibers. With the uniform coating of one or more powder layers, the coated fibers can be easily handled without sticking to one another and can be arranged into a form, such as a mat to be compressed.

### Method 2

### General Procedure

1. The fibers are dried to prepare them to be used as a precursor. The lignocellulosic fiber is dried to a MC of 12-15%, based on dry fiber. The powder can be magnesium oxide (MgO) or a blend thereof with a pigment.
2. A liquid (e.g., water) is added to a mixture of mineral powders and a coupling agent, followed by mixing.
3. The fibers are dipped into the resulting mixture of liquid, coupling agent, and mineral powders to ensure even spreading of the mineral powder particles over a total surface of each of the plurality of lignocellulosic fibers. The coupling agent allows the fibers to be entirely coated with a uniform or substantially uniform coating of mineral powder.

### Method 3

### General Procedure

1. The fibers are dried to prepare them to be used as a precursor. The lignocellulosic fiber is dried to a of MC 12-15%, based on dry fiber. The powder can be magnesium oxide (MgO) or a blend thereof with a pigment.
2. The foam is mixed with the coupling agent, followed by the addition of powdered mineral (MgO).
3. The fibers are added to the resulting foam containing the coupling agent, the dispersed MgO powder, and the fibers are agitated with the foam at high shear for even spreading of the mineral powder particles over a total surface of each of the plurality of lignocellulosic fibers. The coupling agent allows the fibers to be entirely coated with a uniform or substantially uniform coating of mineral powder. Optionally, a mixer, such as tumble mixer, can be used for continuous mixing of the ingredients.
4. Additional layers of MgO particles may be applied to the first layer during the agitation of the foam containing the coupling agent, the dispersed MgO powder, and the fibers. The coupling agent allows the MgO particles to adhere or make the powder layer tacky or adhering on its outer surface or surface area. As a result, the powder particles can then be deposited on the powder coated fibers. With the uniform coating of one or more powder layers, the coated fibers can be easily handled without sticking to one another and can be arranged into a form, such as a mat to be compressed.

Table 1 presents exemplary amounts of the ingredients for the preparation of coated lignocellulosic composites with various target densities.

TABLE 1
Exemplary amounts of the ingredients for the preparation of coated
lignocellulosic composites with various target densities.

| | | Batch | | |
|---|---|---|---|---|
| Ingredient | Measure | 1 | 2 | 3 |

Fiber

| | | | | |
|---|---|---|---|---|
| Fiber | Weight/dry (g) | 500 | 500 | 500 |
| | MC (%) | 19 | 19 | 19 |
| | Weight/wet (g) | 595 | 595 | 595 |

Powder

| | | | | |
|---|---|---|---|---|
| Powder | Weight/dry (g) | 1000 | 1250 | 1500 |
| Total dry ingredients | Weight/dry (g) | 1500 | 1750 | 2000 |
| Dry fiber | % | 33 | 29 | 25 |
| Powder | % | 67 | 71 | 75 |
| Powder per kg of dry | Weight/dry (kg) | 2.00 | 2.50 | 3.00 |
| fiber | | | | |

Coupling agent

| | | | | |
|---|---|---|---|---|
| Water to coupling agent | Weight/dry (g) | 8400 | 8400 | 8400 |
| Coupling agent to water | % | 4.2 | 4.2 | 4.2 |
| ratio | | | | |
| Foaming agent to water | % | 3 | 3 | 3 |
| ratio | | | | |
| Total coupling agent | Weight (g) | 9002 | 9002 | 9002 |
| mixture | | | | |
| Coupling agent | % | 11.1 | 11.1 | 11.1 |

Analysis

| | | | | |
|---|---|---|---|---|
| Dry fiber | Weight/dry (g) | 500 | 500 | 500 |
| Dry fiber | % | 19.27 | 17.57 | 16.16 |
| Mineral powder | Weight/dry (g) | 1000 | 1250 | 1500 |
| Mineral powder | % | 38.54 | 43.94 | 48.47 |
| Coupling agent powder | Weight/dry (g) | 39 | 39 | 39 |
| Coupling agent powder | % | 1.50 | 1.37 | 1.26 |
| Total dry matter | Weight/dry (g) | 1539 | 1789 | 2039 |
| Total dry matter | % | 59.30 | 62.88 | 65.88 |
| Water from fiber | Weight (g) | 95 | 95 | 95 |
| Water from fiber | % | 3.66 | 3.34 | 3.07 |
| Water/coupling agent | Weight (g) | 933 | 933 | 933 |
| mixture | | | | |
| Water/coupling agent | % | 36.0 | 32.8 | 30.1 |
| mixture | | | | |
| Foaming agent | Weight (g) | 28 | 28 | 28 |
| Foaming agent | % | 1.08 | 0.98 | 0.90 |
| Total batch weight | Weight (g) | 2595 | 2845 | 3095 |

### Method 4

A mixer, such as Flexomixer, can be used to prepare a coated lignocellulosic composite.

### General Procedure

1. The water based coupling agent is atomized in the turbulent environment of the Flexomixer.
2. Powdered mineral (MgO) and the fiber particles are added to the atomized water based coupling agent upon continuous mixing.
3. The mixture is agitated at high shear for even spreading of the mineral powder particles over a total surface of each of the plurality of lignocellulosic fibers. The water based coupling agent allows the fibers to be entirely coated with a uniform or substantially uniform coating of mineral powder.
4. Additional layers of MgO particles may be applied to the first layer during the agitation of the foam containing the coupling agent, the dispersed MgO powder, and the fibers.

The advantage of this method is the much lower amount of water needed to prepare a coated lignocellulosic composite. Fiber does not need to be dried to a low MC before mixing and afterwards, less water needs to be dried out.

The Flexomixer principle is based on creating high turbulence in a flexible tube and a rotor turning at high speed in that tube. By constantly changing the shape of the tube by vertically moving rollers against the flexible tube, the turbulent air flow is also changing causing the particles in the air stream to combine.

The air flow and turbulence can be changed in accordance with the desired result, particle shapes and ratios by the shape of the rotor.

### Method 5

A mixer, such as HANSA mixer, can be used to prepare a coated lignocellulosic composite. The HANSA mixer allows for producing a foam mixture with a high load of mineral powder. The HANSA mixer produces foam with a fine foam structure, devoid of bubbles, and containing a minimal amount of water. Chemicals can be added to create the foam and to ensure the adhering of the mineral foam.

### General Procedure

1. The water based coupling agent is atomized in the turbulent environment of the HANSA mixer.
2. Powdered mineral (MgO) and the fiber particles are added to the atomized water based coupling agent upon continuous mixing.
3. The mixture is agitated at high shear for even spreading of the mineral powder particles over a total surface of each of the plurality of lignocellulosic fibers. The water based coupling agent allows the fibers to be entirely coated with a uniform or substantially uniform coating of mineral powder.
4. Additional layers of MgO particles may be applied to the first layer during the agitation of the foam containing the coupling agent, the dispersed MgO powder, and the fibers.

The advantage of this method is the possibility to make an almost water-free MgO tacking foam that can be combined with fiber at a normal MC. Pre-drying the fiber is not necessary with this method.

### Method 6

A mixing machine, such as a machine for producing aerated concrete, can be used to prepare a coated lignocellulosic composite.

### General Procedure

1. The water based coupling agent is mixed with powdered mineral (MgO) and the fiber particles in the mixing machine, such as a machine for producing aerated concrete.
2. The mixture is agitated at high shear to continuously produce foam for even spreading of the mineral powder particles over a total surface of each of the plurality of lignocellulosic fibers. The foam allows the fibers to be entirely coated with a uniform or substantially uniform coating of mineral powder.
3. Additional layers of MgO particles may be applied to the first layer during the agitation of the foam containing the coupling agent, the dispersed MgO powder, and the fibers.

### 6.3. Example 3. Determination of the Amount of Released Softening Agent

The amount of the softening agent can be determined based on the ratio of powder in the coated lignocellulosic composite and cement forming liquid. In the example below, the powdered mineral is magnesium oxy-phosphate (MOP), and the softening agent is the in situ formed ammonium (NH₃) released through the decomposing of the ammonium polyphosphate.

Table 2 outlines the exemplary parameters for determining the amount of the released softening agent (NH₃).

TABLE 2
Exemplary parameters for determining
the amount of the released NH₃.

| | | Batch | | |
|---|---|---|---|---|
| Ingredient | Measure | 1 | 2 | 3 |
| Dry coated lignocellulosic precursor | Weight (g) | 210 | 236 | 270 |
| Dry Fiber | % | 33.0 | 29.0 | 25.0 |
| Dry Fiber | Weight (g) | 69 | 68 | 67 |
| Mineral powder | % | 67.0 | 71.0 | 75.0 |
| Mineral powder | Weight (g) | 141 | 168 | 202 |
| Mineral powder ratio to cementitious | % | 67.5 | 67.5 | 67.5 |
| material | | | | |
| Liquid ratio to cementitious material | % | 32.5 | 32.5 | 32.5 |
| Liquid | Weight (g) | 68 | 81 | 97 |
| Nitrogen from liquid | % | 10.0 | 10.0 | 10.0 |
| Nitrogen from liquid | Weight (g) | 6.8 | 8.1 | 9.7 |
| Softening Agent (Conversion N to NH₃) | Weight (g) | 8.2 | 9.8 | 11.9 |

### 6.4. Example 4. Dimensional Stability of a Densified Engineered Lignocellulosic Composite

Lignocellulose and lignocellulose-based products exhibit both expansion and shrinkage due to changes in temperature and humidity. Temperature changes can further indirectly affect lignocellulose-based products. Higher temperatures can increase the rate of moisture exchange, leading to faster expansion or shrinkage.

Dimensional stability of the densified engineered lignocellulosic composite was assessed following the procedure below.

### General Procedure

1. Expose a lignocellulose-based product to a relative humidity of 0% by submerging the lignocellulose-based product into silica gel powder.
2. Expose a lignocellulose-based product to a relative humidity of 100% by submerging the lignocellulose-based product into distilled water.
3. Adding the results of step 1 and step 2 to afford the dimensional change number.

### Results

The densified engineered lignocellulosic composite of the present disclosure displayed the dimensional stability of from 1.2 to 3.6 mm/m.

### 7. ADDITIONAL EMBODIMENTS

The disclosure is further described by the following non-limiting clauses:

Clause 1. A densified engineered lignocellulosic composite comprising:
a plurality of lignocellulosic fibers, each having a surface area, and
a cementitious material covering the surface area of each of the lignocellulosic fibers,
   wherein the cementitious material is generated by a cement-forming additive reacting with one or more layers of mineral powder particles adhered to the plurality of lignocellulosic fibers by an adhering layer such that a substantially uniform coating of mineral powder particles covers the surface area of each of the lignocellulosic fibers; and
   wherein the lignocellulosic fibers and the cementitious material have been compressed to form the densified engineered lignocellulosic composite.

Clause 2. The densified engineered lignocellulosic composite of clause 1, wherein the densified engineered lignocellulosic composite is resistant to fire.

Clause 3. The densified engineered lignocellulosic composite of clause 1 or 2, wherein the densified engineered lignocellulosic composite exhibits a thermal conductivity ranging from 0.9 to 1.9 W×m⁻¹×K⁻¹, as determined by laser flash analysis.

Clause 4. The densified engineered lignocellulosic composite of clause 3, wherein the densified engineered lignocellulosic composite exhibits a thermal conductivity ranging from 0.9 to 1.9 W×m⁻¹×K⁻¹, as determined by laser flash analysis.

Clause 5. The densified engineered lignocellulosic composite of any one of clauses 1-4, wherein the densified engineered lignocellulosic composite exhibits a dimensional stability ranging from 1 mm/m to 10 mm/m.

Clause 6. The densified engineered lignocellulosic composite of clause 5, wherein the densified engineered lignocellulosic composite exhibits a dimensional stability ranging from 1 mm/m to 10 mm/m, when fully submerged in water.

Clause 7. The densified engineered lignocellulosic composite of any one of clauses 1-6, wherein the densified engineered lignocellulosic composite is substantially stable under relative humidity (RH) of at least 80%.

Clause 8. The densified engineered lignocellulosic composite of any one of clauses 1-7, wherein the densified engineered lignocellulosic composite is recyclable.

Clause 9. The densified engineered lignocellulosic composite of any one of clauses 1-8, wherein the lignocellulosic fiber is selected from wood fiber, plant fiber, or a mixture thereof.

Clause 10. The densified engineered lignocellulosic composite of clause 9, wherein the lignocellulosic fiber is wood fiber.

Clause 11. The densified engineered lignocellulosic composite of clause 9, wherein the lignocellulosic fiber is plant fiber.

Clause 12. The densified engineered lignocellulosic composite of any one of clauses 1-11, wherein the cement-forming additive is an inorganic salt.

Clause 13. The densified engineered lignocellulosic composite of clause 12, wherein the inorganic salt is ammonium polyphosphate.

Clause 14. The densified engineered lignocellulosic composite of clause 13, wherein ammonium polyphosphate is in a liquid form.

Clause 15. The densified engineered lignocellulosic composite of any one of clauses 1-13, wherein the mineral powder is a metal oxide.

Clause 16. The densified engineered lignocellulosic composite of clause 15, wherein the metal oxide is magnesium oxide.

Clause 17. The densified engineered lignocellulosic composite of any one of clauses 1-16, wherein the plurality of lignocellulosic fibers is temporarily softened by a softening agent generated in situ by reacting the cement-forming additive with the one or more layers of mineral powder particles.

Clause 18. The densified engineered lignocellulosic composite of any one of clauses 1-17, wherein a weight ratio of the cementitious material covering the surface area of each of the lignocellulosic fibers to the lignocellulosic fiber is at least 1:1.

Clause 19. The densified engineered lignocellulosic composite of any one of clauses 1-18, wherein the composite further comprises a coupling agent.

Clause 20. The densified engineered lignocellulosic composite of clause 1, wherein:
the plurality of lignocellulosic fibers is a plurality of wood fibers, wherein each of the plurality of wood fibers is coated with a coupling agent;
the mineral powder is magnesium oxide;
the cement-forming additive is ammonium polyphosphate;
the cementitious material is generated by reacting the ammonium polyphosphate with one or more layers of the magnesium oxide forming the substantially uniform coating on the surface area of each of the wood fibers, which releases ammonium as an in situ generated softening agent that temporarily softens the plurality of wood fibers;
the magnesium oxide is dispersed in a foam applied to the lignocellulosic fibers;
the magnesium oxide is temporarily adhered to each of the wood fibers with a coupling agent on the wood fibers and/or on particles of the magnesium oxide prior to generation of the cementitious material; and
the weight ratio of the cementitious material covering the surface area of each of the wood fibers to the wood fiber is at least 1:1.

Clause 21. A coated lignocellulosic composite precursor comprising:
a plurality of lignocellulosic fibers, each having a surface area;
a coupling agent covering the surface area of each of the lignocellulosic fibers,
   wherein the coupling agent generates an adhering layer on the surface area of the lignocellulosic fibers; and
a plurality of mineral powder particles adhered to the adhering layer formed by the coupling agent;
   wherein the plurality of mineral powder particles forms a substantially uniform coating covering the surface area of each of the lignocellulosic fibers through the application via an intermediate suspension.

Clause 22. The coated lignocellulosic composite precursor of clause 21, wherein the mineral powder particles are magnesium oxide particles.

Clause 23. The coated lignocellulosic composite precursor of clause 21 or 22, wherein the coupling agent is an adhesive.

Clause 24. The coated lignocellulosic composite precursor of clause 23, wherein the adhesive is chosen from a monosaccharide, a disaccharide, a polysaccharide, a polyvinyl acetate, a cyanoacrylate, an ethylene vinyl acetate, a protein, and an elastomer.

Clause 25. The coated lignocellulosic composite precursor of any one of clauses 21-24, wherein the substantially uniform coating of the plurality of mineral powder particles is formed by spraying the lignocellulosic fibers with an intermediate suspension comprising the mineral powder particles.

Clause 26. The coated lignocellulosic composite precursor of any one of clauses 21-24, wherein the substantially uniform coating of the plurality of mineral powder particles is formed by mixing the lignocellulosic fibers with an intermediate suspension comprising a mixture of the mineral powder particles and a foam.

Clause 27. The coated lignocellulosic composite precursor of clause 26, wherein the foam comprises a foaming agent.

Clause 28. The coated lignocellulosic composite precursor of clause 27, wherein the foam comprises water and 2 to 5% of a foaming agent.

Clause 29. The coated lignocellulosic composite precursor of any one of clauses 26-28, wherein the lignocellulosic fibers have a moisture content of less than 15% prior to treatment with the foam, and wherein mineral powders particles are deposited on the surface area of the lignocellulosic fibers upon absorption of liquid from the foam into the lignocellulosic fibers.

Clause 30. The coated lignocellulosic composite precursor of any one of clauses 21-29, further comprising a layering agent that is adhered to a surface area of each of the plurality of mineral powder particles.

Clause 31. The coated lignocellulosic composite precursor of any one of clauses 21-30, further comprising one or more additional layers of substantially uniform coating of the mineral powder particles covering the surface area of each of the lignocellulosic fibers, wherein the layering agent adheres the mineral particles to the lignocellulosic fibers.

Clause 32. The coated lignocellulosic composite precursor of clause 29, wherein the layering agent is an adhesive.

Clause 33. The coated lignocellulosic composite precursor of clause 21, wherein the substantially uniform coating of the plurality of mineral powder particles is a first layer formed by treatment of the lignocellulosic fibers with a foam comprising the mineral powder particles dispersed within the foam, and further comprising a second layer of substantially uniform coating covering the first layer, wherein the second layer is formed by treatment of the lignocellulosic fibers with a foam comprising additional mineral powder particles dispersed within the foam combined with an adhesive.

Clause 34. A cementitious composite precursor comprising the coated lignocellulosic composite precursor of clause 21 and a cement-forming additive.

Clause 35. The cementitious composite precursor of clause 34, wherein the cement-forming additive is an inorganic salt.

Clause 36. The cementitious composite precursor of clause 35, wherein the inorganic salt is ammonium polyphosphate.

Clause 37. The cementitious composite precursor of clause 36, wherein the ammonium polyphosphate is in a liquid form.

Clause 38. The cementitious composite precursor of any one of clauses 34-37, wherein the plurality of lignocellulosic fibers of the coated lignocellulosic composite precursor are positioned in a substantially uniform arrangement as a mat.

Clause 39. The cementitious composite precursor of any one of clauses 34-38, wherein the plurality of lignocellulosic fibers of the coated lignocellulosic composite precursor have been sprayed with a liquid prior to positioning in a substantially uniform arrangement as a mat.

Clause 40. The cementitious composite precursor of clause 38 or 39, wherein the mat comprises the liquid and a plurality of layers of the lignocellulosic fibers, each having a surface area that is coated with mineral powder particles.

Clause 41. The cementitious composite precursor of any one of clauses 38-40, wherein the mat of lignocellulosic fibers is positioned on equipment for forming and densifying the cementitious composite precursor into a densified engineered lignocellulosic composite.

Clause 42. The cementitious composite precursor of any one of clauses 38-41, wherein the cement-forming additive is ammonium polyphosphate that is applied onto the mat of lignocellulosic fibers.

Clause 43. The cementitious composite precursor of any one of clauses 34-42, wherein lignin of the lignocellulosic fibers is temporarily softened by an in situ generated softening agent.

Clause 44. The cementitious composite precursor of any one of clauses 34-43, wherein the mineral powder particles are magnesium oxide particles, and the cement-forming additive is ammonium polyphosphate;
wherein the in situ generated softening agent is an in situ generated ammonia released on the surface area of each of the lignocellulosic fibers when the magnesium oxide particles react with the ammonium polyphosphate to form magnesium phosphate cement.

Clause 45. A cementitious composite precursor comprising:
a plurality of lignocellulosic fibers, each having a surface area;
a coupling agent covering the surface area of each of the lignocellulosic fibers,
   wherein the coupling agent generates a temporarily adhering layer on the surface area of the lignocellulosic fibers;
one or more layers of mineral powder particles adhered to the adhering layer formed by the coupling agent, wherein each of the one or more layers form substantially uniform coating covering each of the lignocellulosic fibers; and
a cement-forming additive,
   wherein the mineral powder particles react with the cement-forming additive to form a substantially uniform layer of the cementitious material on the surface area of the coated lignocellulosic fibers.

Clause 46. A coated lignocellulosic fiber comprising:
a surface area;
a coupling agent applied to the surface area of the lignocellulosic fiber,
   wherein the coupling agent generates a temporarily adhering layer on the surface area of the lignocellulosic fiber; and
a first layer of mineral powder particles adhered to the adhering layer of the coupling agent,
   wherein the first layer forms a substantially uniform coating covering the lignocellulosic fiber.

Clause 47. The coated lignocellulosic fiber of clause 46, wherein the coupling agent is an adhesive.

Clause 48. The coated lignocellulosic fiber of clause 46 or 47, wherein the adhesive is chosen from a monosaccharide, a disaccharide, and a polysaccharide.

Clause 49. The coated lignocellulosic fiber of any one of clause 46-48, further comprising:
one or more additional layers of the mineral powder particles applied to the first layer,
wherein particles of the one or more additional layers comprise a layering agent that allows the additional layers to be applied as a substantially uniform coating around the first layer on each of the lignocellulosic fibers.

Clause 50. The coated lignocellulosic fiber of any one of clauses 46-49, wherein the layering agent is an adhesive.

Clause 51. The coated lignocellulosic fiber of clause 50, wherein the adhesive is chosen from a monosaccharide, a disaccharide, and a polysaccharide.

Clause 52. A method of preparing a coated lignocellulosic composite precursor comprising:
drying a plurality of lignocellulosic fibers;
applying a coupling agent on a surface area of a plurality of lignocellulosic fibers,
wherein the coupling agent generates an adhering layer on the surface area of each of the lignocellulosic fibers; and
applying a first layer of a plurality of mineral powder particles to the coupling agent as a substantially uniform coating around each of the lignocellulosic fibers.

Clause 53. The method of clause 52, wherein the coupling agent is an adhesive, wherein the adhesive is chosen from a monosaccharide, a disaccharide, a polysaccharide, a polyvinyl acetate, a cyanoacrylate, an ethylene vinyl acetate, a protein, and an elastomer.

Clause 54. The method of clause 52 or 53, wherein a weight ratio of the mineral powder particles to the lignocellulosic fibers is at least 1:1.

Clause 55. The method of any one of clauses 52-54, wherein the mineral powder particles are magnesium oxide particles, and wherein the lignocellulosic fibers are wood fibers, plant fibers, or a mixture thereof.

Clause 56. The method of any one of clauses 52-55, wherein applying a first layer of a plurality of mineral powder particles to the coupling agent further comprises spraying the plurality of mineral powder particles onto the coupling agent on the lignocellulosic fibers.

Clause 57. The method of any one of clauses 52-56, wherein applying a first layer of a plurality of mineral powder particles to the coupling agent further comprises applying a foam to the coupling agent on the surface area of the plurality of lignocellulosic fibers.

Clause 58. The method of any one of clauses 52-57, further comprising generating the foam with a foaming agent, and dispersing the plurality of mineral powder particles within the foam, wherein the foam comprises water and 2 to 5% of a foaming agent.

Clause 59. The method of any one of clauses 52-58, further comprising agitating the plurality of lignocellulosic fibers with the foam at high shear for even spreading of the plurality of mineral powder particles over a total surface of each of the plurality of lignocellulosic fibers.

Clause 60. The method of any one of clauses 52-59, further comprising:
applying one or more additional layers of the plurality of mineral powder particles to the first layer;
wherein the mineral powder particles of the one or more additional layers comprise a layering agent that allows the additional layers to be applied as a substantially uniform coating around the first layer on each of the lignocellulosic fibers.

Clause 61. The method of any one of clauses 52-60, wherein the layering agent is an adhesive.

Clause 62. The method of any one of clauses 52-61, wherein applying one or more additional layers of the plurality of mineral powder particles to the first layer further comprises applying a foam to the first layer.

Clause 63. The method of any one of clauses 52-62, further comprising:
generating the foam with a foaming agent;
dispersing the plurality of mineral powder particles within the foam; and
adding an adhesive to the foam to form an adhering layer on the plurality of mineral powder particles.

Clause 64. The method of clause 63, further comprising agitating the plurality of lignocellulosic fibers with the foam at high shear for even spreading of the plurality of mineral powder particles over a total surface of each of the plurality of lignocellulosic fibers.

Clause 65. A method of preparing a densified engineered lignocellulosic composite, the method comprising:
applying a coupling agent on a surface area of a plurality of lignocellulosic fibers to generate an adhering layer; and
applying, to the adhering layer, a first layer of a plurality of mineral powder particles as a substantially uniform coating around each of the lignocellulosic fibers;
applying a cement-forming additive to the surface area of the coated lignocellulosic fibers,
positioning the coated lignocellulosic fibers in a substantially uniform arrangement as a mat;
   wherein a cementitious material is generated by the cement-forming additive reacting with one or more layers of the mineral powder particles temporarily adhered as a substantially uniform coating on the surface area of each of the lignocellulosic fibers; and
compressing the lignocellulosic fibers and the cementitious material to form the densified engineered lignocellulosic composite.

Clause 66. The method of clause 65, wherein the coated cellulosic fibers comprise a coated lignocellulosic composite, and wherein the composite is prepared according to the method of claim 52.

Clause 67. The method of clause 65 or 66, wherein the cement-forming additive is an inorganic salt.

Clause 68. The method of clause 67, wherein the inorganic salt is ammonium polyphosphate.

Clause 69. The method of clause 68, wherein ammonium polyphosphate is in a liquid form.

Clause 70. The method of any one of clauses 65-69, wherein the mineral powder particles are metal oxide particles.

Clause 71. The method of clause 70, wherein the metal oxide particles are magnesium oxide particles.

Clause 72. The method of any one of clauses 65-71, wherein the plurality of lignocellulosic fibers is softened by an in situ generated softening agent.

Clause 73. The method of clause 72, wherein the in situ generated softening agent is in situ generated ammonia.

Clause 74. The method of clause 73, wherein the in situ generated ammonia is released when magnesium oxide reacts with ammonium polyphosphate to form magnesium phosphate cement.

Clause 75. The method of clause 73 or 74, wherein the in-situ generated ammonia is recaptured and reused.

Clause 76. The method of any one of clauses 65-75, wherein a weight ratio of the cementitious material covering the surface area of each of the lignocellulosic fibers to the lignocellulosic fiber is at least 1:1.

Clause 77. The method of any one of clauses 65-76, wherein the coupling agent is an adhesive.

Clause 78. The method of clause 77, wherein the adhesive is chosen from a monosaccharide, a disaccharide, a polysaccharide, a polyvinyl acetate, a cyanoacrylate, an ethylene vinyl acetate, a protein, and an elastomer.

Clause 79. The method of any one of clauses 65-78, wherein applying, to the adhering layer, a first layer of a plurality of mineral powder particles further comprises spraying the plurality of mineral powder particles onto the adhering layer on the lignocellulosic fibers.

Clause 80. The method of any one of clauses 65-79, wherein applying, to the adhering layer, a first layer of a plurality of mineral powder particles further comprises applying a foam to the adhering layer on the surface area of the plurality of lignocellulosic fibers.

Clause 81. The method of any one of clauses 65-80, further comprising:
generating the foam with a foaming agent;
dispersing the plurality of mineral powder particles within the foam; and
agitating the plurality of lignocellulosic fibers with the foam at high shear for even spreading of the plurality of mineral powder particles over a total surface of each of the plurality of lignocellulosic fibers.

Clause 82. The method of any one of clauses 65-81, further comprising:
applying one or more additional layers of the plurality of mineral powder particles to the first layer;
wherein the mineral powder particles of the one or more additional layers comprise a layering agent that allows the additional layers to be applied as a substantially uniform coating around the first layer on each of the lignocellulosic fibers.

Clause 83. The method of clause 82, wherein the layering agent is an adhesive, and wherein applying one or more additional layers further comprises:
generating the foam with a foaming agent;
dispersing the plurality of mineral powder particles within the foam; and adding the adhesive to the foam to form an adhering layer on the plurality of mineral powder particles.

Clause 84. The method of any one of clauses 65-83, wherein the mat of lignocellulosic fibers is positioned on equipment for forming densified engineered lignocellulosic composite.

Clause 85. The method of any one of clauses 65-84, wherein the cement-forming additive is ammonium polyphosphate, and wherein the method further comprises applying the ammonium polyphosphate onto the lignocellulosic fibers having the substantially uniform coating as the lignocellulosic fibers are falling onto or being formed into the mat to form the cementitious composite.

Clause 86. The method of any one of clauses 65-85, further comprising heating the cementitious material to at least 150° C. to remove excess of the in situ generated ammonia.

Clause 87. A method of generating an in situ softening agent on coated lignocellulosic fibers, the method comprising:
applying a substantially uniform coating of a plurality of magnesium oxide powder particles to a plurality of lignocellulosic fibers;
   wherein the plurality of lignocellulosic fibers has been treated with a coupling agent on a surface area to form the coated lignocellulosic fibers; and
applying ammonium polyphosphate to the coated lignocellulosic fibers,
   wherein the ammonium polyphosphate reacts with the coating of magnesium oxide powder particles to generate in situ ammonia on the surface area of each of the lignocellulosic fibers as a softening agent.

Clause 88. The method of clause 87, wherein ammonium polyphosphate is in a liquid form.

Clause 89. The method of clause 86 or 87, wherein ammonium polyphosphate is applied by spraying onto the lignocellulosic fibers, wherein each of the lignocellulosic fibers has a substantially uniform coating of magnesium oxide powder particles.

### 8. EQUIVALENTS AND INCORPORATION BY REFERENCE

While aspects of this disclosure have been particularly shown and described with reference to a preferred embodiment and various alternate embodiments, it will be understood by persons skilled in the relevant art that various changes in form and details can be made therein without departing from the scope of the disclosure.

All references, issued patents and patent applications cited within the body of the instant specification are hereby incorporated by reference in their entirety, for all purposes.

1-20. (canceled)

21. A coated lignocellulosic composite precursor comprising:
a plurality of lignocellulosic fibers, each having a surface area;
a coupling agent covering the surface area of each of the lignocellulosic fibers,
wherein the coupling agent generates an adhering layer on the surface area of the lignocellulosic fibers; and
a plurality of mineral powder particles adhered to the adhering layer formed by the coupling agent;
wherein the plurality of mineral powder particles forms a substantially uniform coating covering the surface area of each of the lignocellulosic fibers through the application via an intermediate suspension.

22. The coated lignocellulosic composite precursor of claim 21, wherein the mineral powder particles are magnesium oxide particles.

23. The coated lignocellulosic composite precursor of claim 21, wherein the coupling agent is an adhesive.

24. The coated lignocellulosic composite precursor of claim 23, wherein the adhesive is chosen from a monosaccharide, a disaccharide, a polysaccharide, a polyvinyl acetate, a cyanoacrylate, an ethylene vinyl acetate, a protein, and an elastomer.

25. The coated lignocellulosic composite precursor of claim 21, wherein the substantially uniform coating of the plurality of mineral powder particles is formed by spraying the lignocellulosic fibers with an intermediate suspension comprising the mineral powder particles.

26. The coated lignocellulosic composite precursor of claim 21, wherein the substantially uniform coating of the plurality of mineral powder particles is formed by mixing the lignocellulosic fibers with an intermediate suspension comprising a mixture of the mineral powder particles and a foam.

27. The coated lignocellulosic composite precursor of claim 26, wherein the foam comprises a foaming agent.

28. The coated lignocellulosic composite precursor of claim 27, wherein the foam comprises water and 2 to 5% of a foaming agent.

29. The coated lignocellulosic composite precursor of claim 26, wherein the lignocellulosic have a moisture content of less than 15% prior to treatment with the foam, and wherein mineral powders particles are deposited on the surface area of the lignocellulosic fibers upon absorption of liquid from the foam into the lignocellulosic fibers.

30. The coated lignocellulosic composite precursor of claim 21, further comprising a layering agent that is adhered to a surface area of each of the plurality of mineral powder particles.

31. The coated lignocellulosic composite precursor of claim 21, further comprising one or more additional layers of substantially uniform coating of the mineral powder particles covering the surface area of each of the lignocellulosic fibers, wherein the layering agent adheres the mineral particles to the lignocellulosic fibers.

32. The coated lignocellulosic composite precursor of claim 29, wherein the layering agent is an adhesive.

33. The coated lignocellulosic composite precursor of claim 21, wherein the substantially uniform coating of the plurality of mineral powder particles is a first layer formed by treatment of the lignocellulosic fibers with a foam comprising the mineral powder particles dispersed within the foam, and
further comprising a second layer of substantially uniform coating covering the first layer, wherein the second layer is formed by treatment of the lignocellulosic fibers with a foam comprising additional mineral powder particles dispersed within the foam combined with an adhesive.

34-51. (canceled)

52. A method of preparing a coated lignocellulosic composite precursor comprising:
drying a plurality of lignocellulosic fibers;
applying a coupling agent on a surface area of a plurality of lignocellulosic fibers, wherein the coupling agent generates an adhering layer on the surface area of each of the lignocellulosic fibers; and
applying a first layer of a plurality of mineral powder particles to the coupling agent as a substantially uniform coating around each of the lignocellulosic fibers.

53. The method of claim 52, wherein the coupling agent is an adhesive, wherein the adhesive is chosen from a monosaccharide, a disaccharide, a polysaccharide, a polyvinyl acetate, a cyanoacrylate, an ethylene vinyl acetate, a protein, and an elastomer.

54. (canceled)

55. The method of claim 52, wherein the mineral powder particles are magnesium oxide particles, and wherein the lignocellulosic fibers are wood fibers, plant fibers, or a mixture thereof.

56-57. (canceled)

58. The method of claim 52, further comprising generating the foam with a foaming agent and dispersing the plurality of mineral powder particles within the foam, wherein the foam comprises water and 2 to 5% of a foaming agent.

59. (canceled)

60. The method of claim 52, further comprising:
applying one or more additional layers of the plurality of mineral powder particles to the first layer;
wherein the mineral powder particles of the one or more additional layers comprise a layering agent that allows the additional layers to be applied as a substantially uniform coating around the first layer on each of the lignocellulosic fibers.

61. (canceled)

62. The method of claim 52, wherein applying one or more additional layers of the plurality of mineral powder particles to the first layer further comprises applying a foam to the first layer.

63. The method of claim 52, further comprising:
generating the foam with a foaming agent;
dispersing the plurality of mineral powder particles within the foam; and
adding an adhesive to the foam to form an adhering layer on the plurality of mineral powder particles.

64-89. (canceled)

90. The coated lignocellulosic composite precursor of claim 21, wherein the mineral powder particles are treated with a carrier, wherein the carrier is chosen from a liquid, a gas, a spray gas, a spray liquid, a chemical compound, a slurry, a foam or a combination thereof.

91. The coated lignocellulosic composite precursor of claim 21, wherein the carrier is a suspension that carries the mineral powder particles.

92. The coated lignocellulosic composite precursor of claim 91, wherein the carrier further comprises an adhesive.

93. The coated lignocellulosic composite precursor of claim 21, wherein the plurality of coated lignocellulosic fibers are arranged in a mat in which the coated lignocellulosic fibers are in a substantially uniform arrangement within the mat prior to addition of a cement-forming additive.

94. The coated lignocellulosic composite precursor of claim 93, wherein the plurality of coated lignocellulosic fibers are arranged in a mat in which the coated lignocellulosic fibers are in a substantially uniform arrangement within the mat after addition of a cement-forming additive.

95. The coated lignocellulosic composite precursor of claim 94, further comprising a cement-forming additive added to the mat to form a cementitious composite precursor.

96. The coated lignocellulosic composite precursor of claim 95, wherein the cement-forming additive is an inorganic salt.

97. The coated lignocellulosic composite precursor of claim 96, wherein the inorganic salt is ammonium polyphosphate.

98. The coated lignocellulosic composite precursor of claim 97, wherein the mineral powder particles are magnesium oxide particles, and further comprising ammonium polyphosphate added to the mat, wherein in situ generated ammonia is released on the surface area of each of the lignocellulosic fibers when the magnesium oxide particles react with the ammonium polyphosphate to form magnesium phosphate cement for densifying and hardening into a composite material.
